(19) United States
(12) Patent Application Publication
(10) Pub. No.: US 2023/0389391 A1
(43) Pub. Date: Nov. 30, 2023

(54) DISPLAY DEVICE

(71) Applicant: SAMSUNG DISPLAY CO., LTD., YONGIN-SI (KR)

(72) Inventors: HEERIM SONG, YONGIN-SI (KR); HEEJEAN PARK, YONGIN-SI (KR); CHEOL-GON LEE, YONGIN-SI (KR); MUKYUNG JEON, YONGIN-SI (KR)

(21) Appl. No.: 18/176,589

(22) Filed: Mar. 1, 2023

(30) Foreign Application Priority Data
May 26, 2022 (KR) 10-2022-0064464

(51) Int. Cl. H10K 59/65; G06F 21/32; G06V 40/13; H10K 59/121; H10K 59/131

(52) U.S. Cl. CPC H10K 59/65; G06F 21/32; G06V 40/1318; H10K 59/1213; H10K 59/131

(57) ABSTRACT

A display device in which an active area and a peripheral area adjacent to the active area are defined includes a base layer, a circuit layer disposed on the base layer, and an element layer disposed on the circuit layer and including a light emitting element and a light receiving element. The circuit layer includes a pixel driving circuit connected to the light emitting element, a sensor driving circuit connected to the light receiving element, a plurality of reset voltage wirings disposed in the active area and that provide a reset voltage to the sensor driving circuit, and a reset voltage reinforcement wiring disposed in the peripheral area, connected to the plurality of reset voltage wirings, and extending in a first direction.

### CROSS-REFERENCE TO RELATED APPLICATION

This U.S. non-provisional patent application claims priority under 35 U.S.C. § 119 to Korean Patent Application No. 10-2022-0064464, filed on May 26, 2022, the disclosure of which is hereby incorporated by reference in its entirety.

### TECHNICAL FIELD

Embodiments of the present inventive concept relate to a display device, and more particularly, to a display device capable of recognizing biometric information.

### DISCUSSION OF RELATED ART

A display device provides a variety of functions by which a user may interact with the display device, such as displaying an image to provide information to the user and detecting the user's input. Recent display devices additionally include a function for sensing the user's biometric information.

Biometric information recognition methods include a capacitive method for sensing a change in capacitance generated between electrodes, an optical method for sensing incident light using an optical sensor, an ultrasonic method for sensing vibration using, e.g., a piezoelectric device, and the like.

### SUMMARY

Embodiments of the present inventive concept provide a display device capable of increasing the sensing performance of a sensor for biometric information recognition.

An embodiment of the inventive concept provides a display device in which an active area and a peripheral area adjacent to the active area are defined. The display device includes a base layer, a circuit layer disposed on the base layer, and an element layer disposed on the circuit layer and including a light emitting element and a light receiving element.

In an embodiment, the circuit layer includes a pixel driving circuit connected to the light emitting element, a sensor driving circuit connected to the light receiving element, a plurality of reset voltage wirings disposed in the active area and configured to provide a reset voltage to the sensor driving circuit, and a reset voltage reinforcement wiring disposed in the peripheral area, connected to the plurality of reset voltage wirings, and extending in a first direction.

In an embodiment, an active area in which an image is displayed and a peripheral area including a first peripheral area disposed on an upper side of the active area, a second peripheral area disposed on a lower side of the active area, and a third peripheral area and a fourth peripheral area respectively disposed on left and right sides of the active area, are defined in a display device. The display device includes a base layer, a circuit layer disposed on the base layer, and an element layer disposed on the circuit layer and including a light emitting element and a light receiving element.

In an embodiment, the circuit layer includes a reset voltage reinforcement wiring disposed in the first peripheral area and the second peripheral area and connected to reset voltage wirings of the active area, and a reset control reinforcement wiring, a first initialization voltage reinforcement wiring, and a second initialization voltage reinforcement wiring disposed in the third peripheral area and the fourth peripheral area.

### BRIEF DESCRIPTION OF THE DRAWINGS

The above and other features of the present inventive concept will become more apparent by describing in detail embodiments thereof with reference to the accompanying drawings, in which:

FIG. 1 is a perspective view of a display device according to an embodiment of the inventive concept;

FIG. 2 is a cross-sectional view of a display device according to an embodiment of the inventive concept;

FIG. 3 is a block diagram of a display device according to an embodiment of the inventive concept;

FIGS. 4A and 4B are enlarged plan views of portions of display panels according to embodiments of the inventive concept;

FIG. 5A is a circuit diagram illustrating one of pixels and a corresponding sensor according to an embodiment of the inventive concept;

FIG. 5B is a waveform diagram referred to when describing operations of the pixel and the sensor illustrated in FIG. 5A;

FIG. 6 is a cross-sectional view of a display panel according to an embodiment of the inventive concept;

FIG. 7 is a plan view of a display device according to an embodiment of the inventive concept;

FIGS. 8A to 8G are views illustrating arrangements of conductive patterns included in a circuit layer according to an embodiment of the inventive concept;

FIGS. 9A to 9G are views illustrating arrangements of conductive patterns included in a circuit layer according to an embodiment of the inventive concept;

FIGS. 10A to 10I are views illustrating arrangements of conductive patterns included in a circuit layer according to an embodiment of the inventive concept;

FIG. 11A is an enlarged view of a portion of a circuit layer according to an embodiment of the inventive concept;

FIGS. 11B and 11C are cross-sectional views taken along line I-I′ of FIG. 11A according to an embodiment of the inventive concept;

FIG. 12A is an enlarged view of a portion of a circuit layer according to an embodiment of the inventive concept;

FIG. 12B is an enlarged view of the area XX′ of FIG. 12A; and

FIGS. 13A and 13B are cross-sectional views illustrating light emitting elements and a light receiving element of a display panel according to an embodiment of the inventive concept.

### DETAILED DESCRIPTION

Embodiments of the present inventive concept will be described more fully hereinafter with reference to the accompanying drawings. Like reference numerals may refer to like elements throughout the accompanying drawings.

It will be understood that when a component such as a film, a region, a layer, etc., is referred to as being “on”, “connected to”, “coupled to”, or “adjacent to” another component, it can be directly on, connected, coupled, or adjacent to the other component, or intervening components may be present. It will also be understood that when a component is referred to as being “between” two components, it can be the only component between the two components, or one or more intervening components may also be present. It will also be understood that when a component is referred to as “covering” another component, it can be the only component covering the other component, or one or more intervening components may also be covering the other component. Other words used to describe the relationships between components should be interpreted in a like fashion.

As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present inventive concept.

As used herein, the singular forms, “a”, “an”, and “the” are intended to include the plural forms as well, unless the context clearly indicates otherwise.

Spatially relative terms, such as “beneath”, “below”, “lower”, “above”, and “upper”, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

It will be further understood that the terms “include” or “have”, when used in this specification, specify the presence of stated features, integers, steps, operations, elements, components, and/or groups thereof, but do not preclude the presence or addition of one or more other features, integers, steps, operations, elements, components, and/or groups thereof.

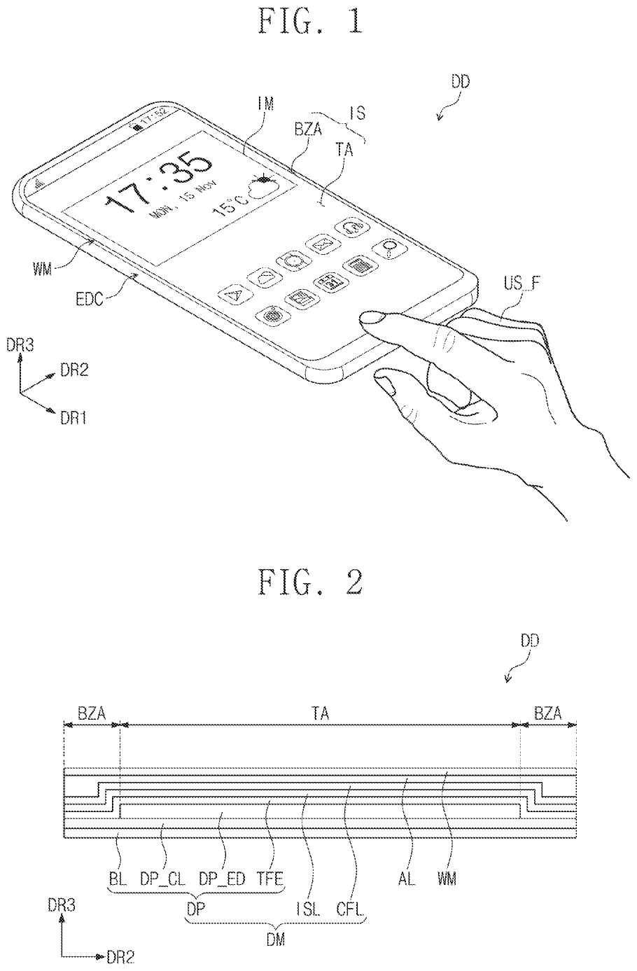

FIG. 1 is a perspective view of a display device according to an embodiment of the inventive concept. FIG. 2 is a cross-sectional view of a display device according to an embodiment of the inventive concept.

Referring to FIGS. 1 and 2, a display device DD according to an embodiment of the inventive concept may have a rectangular shape having long sides (e.g., left and right sides) parallel to a first direction DR1 and short sides (e.g., upper and lower sides) parallel to a second direction DR2 crossing the first direction DR1. However, the display device DD is not limited thereto, and may have various shapes such as, for example, a circular shape and a polygonal shape.

The display device DD may be a device that is activated according to an electrical signal. The display device DD may include various embodiments. For example, the display device DD may be applied to electronic devices such as a smartwatch, a tablet, a laptop computer, a personal computer, and a smart television.

Hereinafter, a normal direction substantially perpendicular to a plane defined by the first direction DR1 and the second direction DR2 is defined as a third direction DR3. In this specification, “when viewed in a plane” or “when viewed in a plan view” may mean a state of being viewed in the third direction DR3.

A top surface of the display device DD may be defined as a display surface IS and may be parallel to the plane defined by the first direction DR1 and the second direction DR2 Images IM generated by the display device DD may be provided to a user through the display surface IS.

The display surface IS may be divided into a transmissive area TA and a bezel area BZA. The transmissive area TA may be an area in which the images IM are displayed. A user views the images IM through the transmissive area TA. In an embodiment, the transmissive area TA is illustrated as a rectangular shape having round vertices. However, this is illustrated as an example, and the transmissive area TA is not limited thereto and may have various shapes.

The bezel area BZA is adjacent to the transmissive area TA. The bezel area BZA may have a predetermined color. The bezel area BZA may surround the transmissive area TA. Accordingly, the shape of the transmissive area TA may be substantially defined by the bezel area BA. However, this is illustrated as an example, and the bezel area BZA may be disposed adjacent to only one side of the transmissive area TA or may be omitted according to embodiments.

The display device DD may sense an external input applied from outside of the display device DD. The external input may include various types of inputs provided from outside of the display device DD. For example, the external input may include an external input (e.g., hovering) applied close to the display device DD or adjacent to the display device DD at a predetermined distance without making direct contact with the display device DD, in addition to a contact by a part of a body such as a user's finger US_F or by a separate device (e.g., an active pen, a digitizer, etc.). In addition, the external input may have various types such as force, pressure, temperature, and light.

The display device DD may sense a user's biometric information applied from outside of the display device DD. A biometric information sensing area capable of sensing the user's biometric information may be provided on the display surface IS of the display device DD. The biometric information sensing area may be provided in the entirety of the transmissive area TA or may be provided in a partial area of the transmissive area TA. For example, the biometric information sensing area may correspond to the entire size of the transmissive area TA in an embodiment, or may correspond to a partial area less than the entirety of the transmissive area TA in an embodiment. FIG. 1 illustrates, According to an embodiment of the inventive concept, a case in which the entirety of the transmissive area TA is utilized as the biometric information sensing area.

The display device DD may include a window WM, a display module DM, and a housing EDC. In an embodiment, the window WM and the housing EDC combine to constitute the appearance of the display device DD.

A front surface of the window WM defines the display surface IS of the display device DD. The window WM may include an optically transparent insulating material. For example, the window WM may include glass or plastic. The window WM may have a multilayer structure or a single-layer structure. For example, the window WM may include a plurality of plastic films bonded with an adhesive or may include a glass substrate and a plastic film bonded with an adhesive.

The display module DM may include a display panel DP and an input sensing layer ISL. The display panel DP may display an image according to an electrical signal, and the input sensing layer ISL may sense an external input applied from outside of the display device DD. The external input may be provided in various types.

The display panel DP according to an embodiment of the inventive concept may be a light emitting display panel, but is not particularly limited. For example, the display panel DP may be an organic light emitting display panel, an inorganic light emitting display panel, or a quantum dot light emitting display panel. A light emitting layer of the organic light emitting display panel may include an organic light emitting material, and a light emitting layer of the inorganic light emitting display panel may include an inorganic light emitting material. A light emitting layer of the quantum dot light emitting display panel may include, for example, quantum dots, quantum rods, and the like. Hereinafter, the display panel DP is described as the organic light emitting display panel.

Referring to FIG. 2, the display panel DP includes a base layer BL, a circuit layer DP_CL, an element layer DP_ED, and an encapsulation layer TFE. The display panel DP according to an embodiment of the inventive concept may be a flexible display panel. However, embodiments of the inventive concept are not limited thereto. For example, the display panel DP may be a foldable display panel that is folded about a folding axis, or a rigid display panel.

The base layer BL may include a synthetic resin layer. The synthetic resin layer may be, for example, a polyimide-based resin layer, and the material thereof is not particularly limited. In addition, the base layer BL may include, for example, a glass substrate, a metal substrate, an organic/inorganic composite material substrate, or the like.

The circuit layer DP_CL is disposed on the base layer BL. The circuit layer DP_CL is disposed between the base layer BL and the element layer DP_ED. The circuit layer DP_CL includes at least one insulating layer and a circuit element. Hereinafter, the insulating layer included in the circuit layer DP_CL is referred to as an intermediate insulating layer. The intermediate insulating layer includes at least one intermediate inorganic film and at least one intermediate organic film. The circuit element may include, for example, a pixel driving circuit included in each of a plurality of pixels for displaying an image, a sensor driving circuit included in each of a plurality of sensors for recognizing external information, and the like. The external information may be biometric information. According to an embodiment of the inventive concept, the sensor may be a fingerprint recognition sensor, a proximity sensor, an iris recognition sensor, and the like. In addition, the sensor may be an optical sensor for recognizing biometric information in an optical manner. The circuit layer DP_CL may further include signal lines connected to the pixel driving circuit and/or the sensor driving circuit.

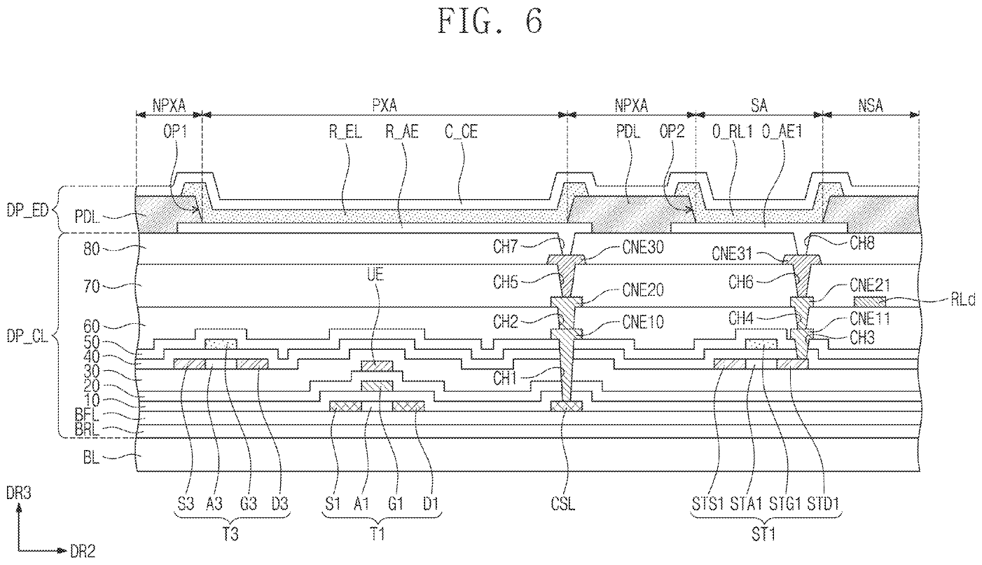

The element layer DP_ED may include a light emitting element included in each of the pixels and a light receiving element included in each of the sensors. According to an embodiment of the inventive concept, the light receiving element may be a photodiode. The light receiving element may be a sensor that senses or responds to light reflected by a user's fingerprint. The circuit layer DP_CL and the element layer DP_ED will be described in detail below with reference to FIG. 6 and FIGS. 8A to 10I.

The encapsulation layer TFE seals the element layer DP_ED. The encapsulation layer TFE may include at least one organic film and at least one inorganic film. The inorganic film may include an inorganic material and may protect the element layer DP_ED from, for example, moisture/oxygen. The inorganic film may include, for example, a silicon nitride layer, a silicon oxynitride layer, a silicon oxide layer, a titanium oxide layer, an aluminum oxide layer, or the like, but is not particularly limited thereto. The organic film may include an organic material and may protect the element layer DP_ED from foreign matter such as, for example, dust particles.

The input sensing layer ISL may be provided on the display panel DP. The input sensing layer ISL may be directly disposed on the encapsulation layer TFE. According to an embodiment of the inventive concept, the input sensing layer ISL may be provided on the display panel DP by a continuous process. That is, in an embodiment, when the input sensing layer ISL is directly disposed on the display panel DP, an adhesive film is not disposed between the input sensing layer ISL and the encapsulation layer TFE. Alternatively, an adhesive film may be disposed between the input sensing layer ISL and the display panel DP in an embodiment. In this case, after being manufactured through a process separate from that of the display panel DP instead of being manufactured by a continuous process together with the display panel DP, the input sensing layer ISL may be fixed to a top surface of the display panel DP by the adhesive film.

The input sensing layer ISL may sense an external input (e.g., a user's touch), convert the external input into a predetermined input signal, and provide the input signal to the display panel DP. The input sensing layer ISL may include a plurality of sensing electrodes for sensing an external input. The sensing electrodes may sense the external input in a capacitive manner. The display panel DP may receive the input signal from the input sensing layer ISL and generate an image corresponding to the input signal.

The display module DM may further include a color filter layer CFL. According to an embodiment of the inventive concept, the color filter layer CFL may be disposed on the input sensing layer ISL. However, embodiments of the inventive concept are not limited thereto. The color filter layer CFL may also be disposed between the display panel DP and the input sensing layer ISL. The color filter layer CFL may include a plurality of color filters and a black matrix.

Details about the structures of the input sensing layer ISL and the color filter layer CFL will be described below.

The display device DD according to an embodiment of the inventive concept may further include an adhesive layer AL. The window WM may be attached to the input sensing layer ISL by the adhesive layer AL. The adhesive layer AL may include, for example, an optically clear adhesive, an optically clear adhesive resin, or a pressure sensitive adhesive (PSA).

The housing EDC combines with the window WM to provide a predetermined internal space. The display module DM may be accommodated in the internal space. The housing EDC may include a material having a relatively high rigidity. For example, the housing EDC may include glass, plastic, metal, or a plurality of frames and/or plates constituted of combinations thereof. The housing EDC may securely protect the components of the display device DD accommodated in the internal space from external impact. In an embodiment, a battery module for supplying power utilized for the overall operation of the display device DD, and the like may be disposed between the display module DM and the housing EDC.

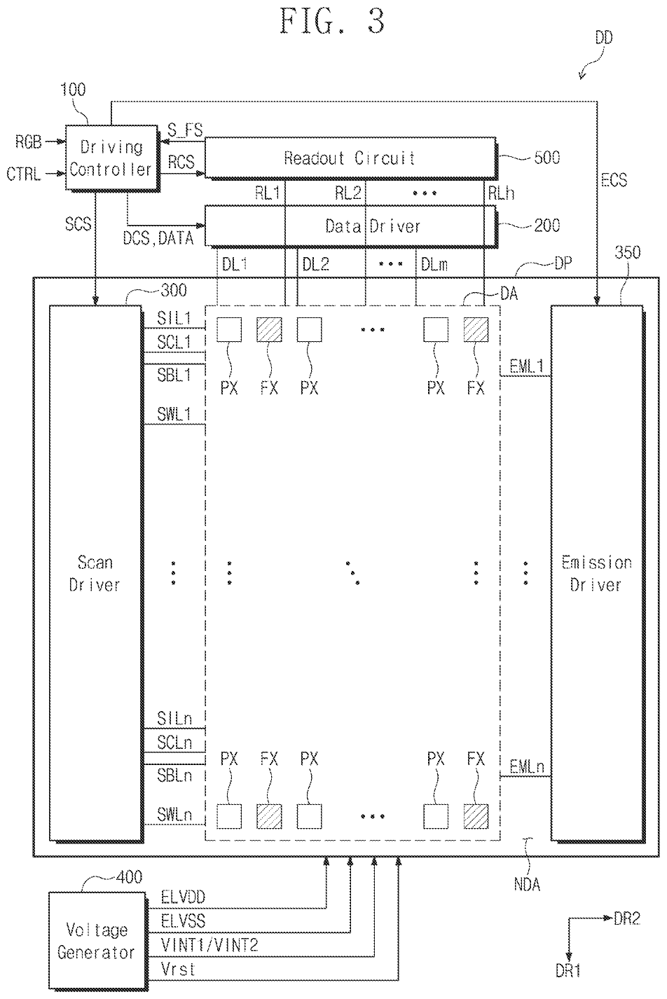

FIG. 3 is a block diagram of a display device according to an embodiment of the inventive concept.

Referring to FIG. 3, the display device DD includes the display panel DP, a panel driver, and a driving controller 100. According to an embodiment of the inventive concept, the panel driver includes a data driver 200, a scan driver 300, an emission driver 350, a voltage generator 400, and a readout circuit 500.

The driving controller 100 receives an image signal RGB and a control signal CTRL. The driving controller 100 generates image data DATA obtained by converting the data format of the image signal RGB according to an interface specification between the driving controller 100 and the data driver 200. The driving controller 100 outputs a first control signal SCS, a second control signal ECS, a third control signal DCS, and a fourth control signal RCS.

The data driver 200 receives the third control signal DCS and the image data DATA from the driving controller 100. The data driver 200 converts the image data DATA into data signals and outputs the data signals to a plurality of data lines DL1 to DLm, which are described below, where m is a positive integer. The data signals are analog voltages corresponding to gradation values of the image data DATA.

The scan driver 300 receives the first control signal SCS from the driving controller 100. The scan driver 300 may output scan signals to scan lines in response to the first control signal SCS.

The voltage generator 400 generates voltages utilized for the operation of the display panel DP. In an embodiment, the voltage generator 400 generates a first driving voltage ELVDD, a second driving voltage ELVSS, a first initialization voltage VINT1, and a second initialization voltage VINT2.

The display panel DP may include an active area DA corresponding to the transmissive area TA (illustrated in FIG. 1) and a peripheral area NDA corresponding to the bezel area BZA (illustrated in FIG. 1).

The display panel DP may include a plurality of pixels PX disposed in the active area DA and a plurality of sensors FX disposed in the active area DA. According to an embodiment of the inventive concept, each of the plurality of sensors FX may be disposed between two pixels PX adjacent to each other. The plurality of pixels PX and the plurality of sensors FX may be alternately arranged in the first and second directions DR1 and DR2. However, embodiments of the inventive concept are not limited thereto. That is, two or more pixels PX may be disposed between two sensors FX adjacent to each other in the first direction DR1 among the plurality of sensors FX, or two or more pixels PX may be disposed between two sensors FX adjacent to each other in the second direction DR2 among the plurality of sensors FX, according to embodiments.

The display panel DP further includes initialization scan lines SIL1 to SILn, compensation scan lines SCL1 to SCLn, write scan lines SWL1 to SWLn, black scan lines SBL1 to SBLn, emission control lines EML1 to EMLn, the data lines DL1 to DLm, and readout lines RL1 to RLh, where each of n, m and h is a positive integer. The initialization scan lines SIL1 to SILn, the compensation scan lines SCL1 to SCLn, the write scan lines SWL1 to SWLn, the black scan lines SBL1 to SBLn, and the emission control lines EML1 to EMLn extend in the second direction DR2. The initialization scan lines SIL1 to SILn, the compensation scan lines SCL1 to SCLn, the write scan lines SWL1 to SWLn, the black scan lines SBL1 to SBLn, and the emission control lines EML1 to EMLn are spaced apart from each other in the first direction DR1. The data lines DL1 to DLm and the readout lines RL1 to RLh extend in the first direction DR1 and are spaced apart from each other in the second direction DR2.

Each of the plurality of pixels PX is electrically connected to a corresponding one of the initialization scan lines SIL1 to SILn, a corresponding one of the compensation scan lines SCL1 to SCLn, a corresponding one of the write scan lines SWL1 to SWLn, a corresponding one of the black scan lines SBL1 to SBLn, a corresponding one of the emission control lines EML1 to EMLn, and a corresponding one of the data lines DL1 to DLm. For example, each of the plurality of pixels PX may be electrically connected to four scan lines. However, the number of scan lines connected to each of the pixels PX is not limited thereto and may be changed according to embodiments.

Each of the plurality of sensors FX is electrically connected to a corresponding one of the write scan lines SWL1 to SWLn and a corresponding one of the readout lines RL1 to RLh. Each of the plurality of sensors FX may be electrically connected to one scan line. However, embodiments of the inventive concept are not limited thereto. The number of scan lines connected to each of the sensors FX may be changed. According to an embodiment of the inventive concept, the number of the readout lines RL1 to RLh may be smaller than or equal to the number of the data lines DL1 to DLm. For example, the number of readout lines RL1 to RLh may correspond to ½, ¼, ⅛, or the like of the number of the data lines DL1 to DLm.

The scan driver 300 may be disposed in the peripheral area NDA of the display panel DP. The scan driver 300 receives the first control signal SCS from the driving controller 100. In response to the first control signal SCS, the scan driver 300 outputs initialization scan signals to the initialization scan lines SIL1 to SILn and outputs compensation scan signals to the compensation scan lines SCL1 to SCLn. In addition, in response to the first control signal SCS, the scan driver 300 may output write scan signals to the write scan lines SWL1 to SWLn and may output black scan signals to the black scan lines SBL1 to SBLn. Alternatively, the scan driver 300 may include first and second scan drivers. The first scan driver may output the initialization scan signals and the compensation scan signals, and the second scan driver may output the write scan signals and the black scan signals.

The emission driver 350 may be disposed in the peripheral area NDA of the display panel DP. The emission driver 350 receives the second control signal ECS from the driving controller 100. The emission driver 350 may output emission control signals to the emission control lines EML1 to EMLn in response to the second control signal ECS. Alternatively, the scan driver 300 may be connected to the emission control lines EML1 to EMLn. In this case, the emission driver 350 may be omitted, and the scan driver 300 may output the emission control signals to the emission control lines EML1 to EMLn.

The readout circuit 500 receives the fourth control signal RCS from the driving controller 100. The readout circuit 500 may receive readout signals from the readout lines RL1 to RLh in response to the fourth control signal RCS. The readout circuit 500 may process the readout signals received from the readout lines RL1 to RLh and provide the driving controller 100 with detection signals S_FS obtained by processing the received readout signals. The driving controller 100 may recognize biometric information on the basis of the detection signals S_FS.

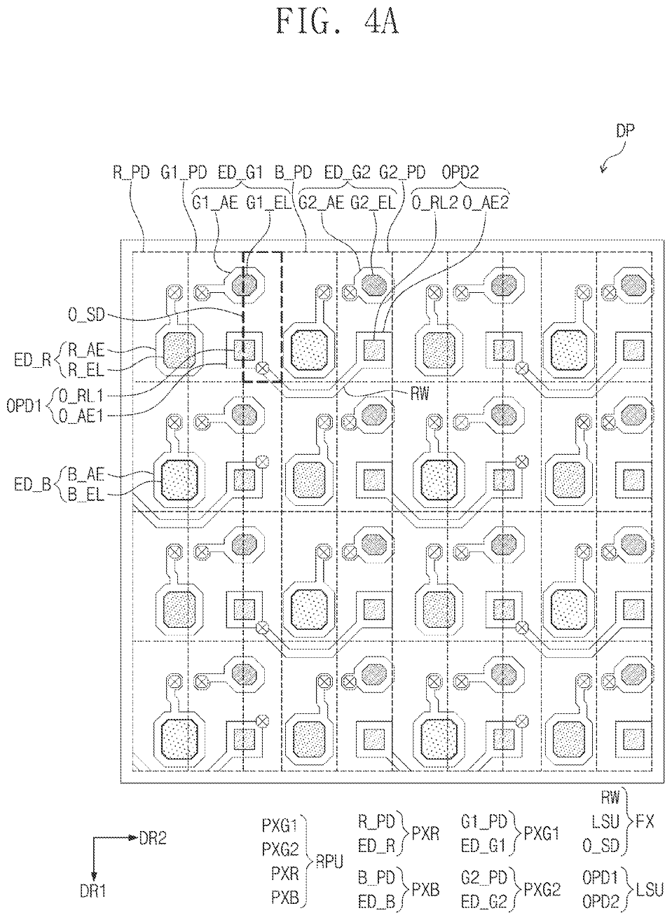

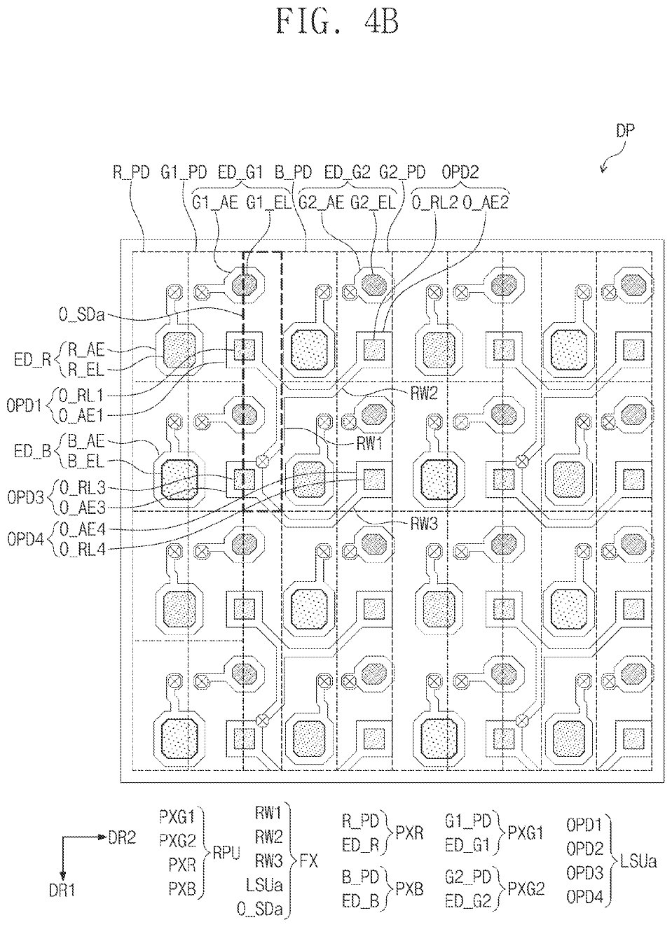

FIGS. 4A and 4B are enlarged plan views of portions of display panels according to embodiments of the inventive concept.

Referring to FIG. 4A, the display panel DP includes a plurality of pixels PXR, PXG1, PXG2, and PXB, and the plurality of sensors FX.

The plurality of pixels PXR, PXG1, PXG2, and PXB may be grouped into a plurality of reference pixel units RPU. According to an embodiment of the inventive concept, each of the reference pixel units RPU may include four pixels, that is, two first pixels PXG1 and PXG2 (hereinafter referred to as first and second green pixels PXG1 and PXG2), a third pixel PXR (hereinafter referred to as a red pixel PXR), and a fourth pixel PXB (hereinafter referred to as a blue pixel PXB). However, the number of pixels included in each of the reference pixel units RPU is not limited thereto. Alternatively, each of the reference pixel units RPU may include three pixels, that is, the first green pixel PXG1 (or the second green pixel PXG2), the red pixel PXR, and the blue pixel PXB.

The first and second green pixels PXG1 and PXG2 respectively include first and second light emitting elements ED_G1 and ED_G2 (hereinafter referred to as first and second green light emitting elements ED_G1 and ED_G2), the red pixel PXR includes a third light emitting element ED_R (hereinafter referred to as a red light emitting element ED_R), and the blue pixel PXB includes a fourth light emitting element ED_B (hereinafter referred to as a blue light emitting element ED_B). According to an embodiment of the inventive concept, each of the first and second green light emitting elements ED_G1 and ED_G2 outputs first color light (e.g., green light), the red light emitting element ED_R outputs second color light (e.g., red light) different from the first color light, and the blue light emitting element ED_B outputs third color light (e.g., blue light) different from the first and second color light. The green light output from the first green light emitting element ED_G1 may have the same wavelength band as the green light output from the second green light emitting element ED_G2.

In the first and second directions DR1 and DR2, the red light emitting elements ED_R and the blue light emitting elements ED_B may be alternately and repeatedly arranged. The first and second green light emitting elements ED_G1 and ED_G2 are alternately and repeatedly arranged in the first direction DR1 and in the second direction DR2. In the first and second directions DR1 and DR2, the first and second green light emitting elements ED_G1 and ED_G2 may be arranged in rows and columns respectively different from rows and columns in which the red light emitting elements ED_R and the blue light emitting elements ED_B are arranged.

According to an embodiment of the inventive concept, the red light emitting element ED_R may have a size larger than that of each of the first and second green light emitting elements ED_G1 and ED_G2. In addition, the blue light emitting element ED_B may have a size larger than or the same as that of the red light emitting element ED_R. The size of each of the light emitting elements ED_R, ED_G1, ED_G2, and ED_B is not limited thereto and may be variously modified according to embodiments. For example, in an embodiment of the inventive concept, the light emitting elements ED_R, ED_G1, ED_G2, and ED_B may also have the same size.

The first and second green light emitting elements ED_G1 and ED_G2 may have shapes different from those of the red and blue light emitting elements ED_R and ED_B. According to an embodiment of the inventive concept, each of the red and blue light emitting elements ED_R and ED_B may have an octagonal shape longer in the first direction DR1 than in the second direction DR2. The red and blue light emitting elements ED_R and ED_B may have the same or different sizes but have the same shape. The shape of each of the red and blue light emitting elements ED_R and ED_B is not limited thereto. For example, each of the red and blue light emitting elements ED_R and ED_B may have an octagonal shape having the same lengths in the first direction DR1 and the second direction DR2, or may have one of a square shape and a rectangular shape.

Each of the first and second green light emitting elements ED_G1 and ED_G2 may have an octagonal shape longer in the second direction DR2 than in the first direction DR1. According to an embodiment of the inventive concept, the first and second green light emitting elements ED_G1 and ED_G2 have the same size and the same shape. However, the shapes of the first and second green light emitting elements ED_G1 and ED_G2 are not limited thereto. Each of the first and second green light emitting elements ED_G1 and ED_G2 may have an octagonal shape having the same lengths in the first direction DR1 and the second direction DR2, or may have one of a square shape and a rectangular shape.

The first green light emitting element ED_G1 is electrically connected to a first green pixel driving circuit G1_PD. For example, the first green light emitting element ED_G1 includes a first green anode electrode G1_AE and a first green light emitting layer G1_EL, and the first green anode electrode G1_AE is connected to the first green pixel driving circuit G1_PD through a contact hole. The second green light emitting element ED_G2 is electrically connected to a second green pixel driving circuit G2_PD. For example, the second green light emitting element ED_G2 includes a second green anode electrode G2_AE and a second green light emitting layer G2_EL, and the second green anode electrode G2_AE is connected to the second green pixel driving circuit G2_PD through a contact hole.

The first green light emitting layer G1_EL and the second green light emitting layer G2_EL may have the same sizes. The first green light emitting layer G1_EL and the second green light emitting layer G2_EL may have the same or different shapes. According to an embodiment of the inventive concept, the first green light emitting layer G1_EL and the second green light emitting layer G2_EL have different shapes in the same plane. The first green anode electrode G1_AE and the second green anode electrode G2_AE may have different sizes and different shapes. The red light emitting element ED_R is electrically connected to a red pixel driving circuit R_PD. For example, the red light emitting element ED_R includes a red anode electrode R_AE and a red light emitting layer R_EL, and the red anode electrode R_AE is connected to the red pixel driving circuit R_PD through a contact hole. The blue light emitting element ED_B is electrically connected to a blue pixel driving circuit B_PD. For example, the blue light emitting element ED_B includes a blue anode electrode B_AE and a blue light emitting layer B_EL, and the blue anode electrode B_AE is connected to the blue pixel driving circuit B_PD through a contact hole.

Each of the sensors FX includes a light sensing unit LSU and a sensor driving circuit O_SD. The light sensing unit LSU may include one or more light receiving elements. According to an embodiment of the inventive concept, the light sensing unit LSU includes k number of light receiving elements, and one of the k number of light receiving elements is connected to the sensor driving circuit O_SD. Here, k may be a positive integer equal to or greater than two. FIG. 4A illustrates a case in which k is two. When k is two, the light sensing unit LSU includes two light receiving elements (hereinafter referred to as first and second light receiving elements OPD1 and OPD2). According to an embodiment of the inventive concept, two light receiving elements (e.g., the first and second light receiving elements OPD1 and OPD2) may be disposed to correspond to one reference pixel unit RPU. However, the number of light receiving elements disposed to correspond to each of the reference pixel units RPU is not limited thereto. For example, in an embodiment, one light receiving element may be disposed to correspond to each of the reference pixel units RPU.

Each of the first and second light receiving elements OPD1 and OPD2 is disposed between corresponding red and blue light emitting elements ED_R and ED_B in the second direction DR2. Each of the first and second light receiving elements OPD1 and OPD2 may be disposed adjacent to a corresponding first green light emitting element ED_G1 or a corresponding second green light emitting element ED_G2 in the first direction DR1. In a first row of the reference pixel units, the first light receiving element OPD1 and the first green light emitting element ED_G1 are adjacent to each other in the first direction DR1, and the second light receiving element OPD2 and the second green light emitting element ED_G2 are adjacent to each other in the first direction DR1. In a second row of the reference pixel units, the first light receiving element OPD1 and the second green light emitting element ED_G2 are adjacent to each other in the first direction DR1, and the second light receiving element OPD2 and the first green light emitting element ED_G1 are adjacent to each other in the first direction DR1. According to an embodiment of the inventive concept, each of the first and second light receiving elements OPD1 and OPD2 is disposed between corresponding first and second green light emitting elements ED_G1 and ED_G2 adjacent to each other in the first direction DR1.

The first and second light receiving elements OPD1 and OPD2 may have the same size and the same shape. Each of the first and second light receiving elements OPD1 and OPD2 may have a size smaller than that of each of the red and blue light emitting elements ED_R and ED_B. According to an embodiment of the inventive concept, each of the first and second light receiving elements OPD1 and OPD2 may have a size smaller than or equal to that of each of the first and second green light emitting elements ED_G1 and ED_G2. However, the size of each of the first and second light receiving elements OPD1 and OPD2 is not particularly limited and may be variously modified according to embodiments. Each of the first and second light receiving elements OPD1 and OPD2 may have a shape different from that of each of the red and blue light emitting elements ED_R and ED_B. According to an embodiment of the inventive concept, each of the first and second light receiving elements OPD1 and OPD2 may have a square shape. The shape of each of the first and second light receiving elements OPD1 and OPD2 is not limited thereto. Alternatively, each of the first and second light receiving elements OPD1 and OPD2 may have a rectangular shape longer in the first direction DR1 than in the second direction DR2.

The sensor driving circuit O_SD is connected to one (e.g., the first light receiving element OPD1) of the first and second light receiving elements OPD1 and OPD2. In the first direction DR1, the sensor driving circuit O_SD may have the same length as the red and blue pixel driving circuits R_PD and B_PD. The sensor driving circuit O_SD may overlap one (e.g., the first light receiving element OPD1) of the first and second light receiving elements OPD1 and OPD2 when viewed in a plane. The sensor driving circuit O_SD may overlap one (e.g., the first green light emitting element ED_G1) of the first and second green light emitting elements ED_G1 and ED_G2 when viewed in a plane.

The first light receiving element OPD1 includes a first sensing anode electrode O_AE1 and a first photoelectric conversion layer O_RL1, and the second light receiving element OPD2 includes a second sensing anode electrode O_AE2 and a second photoelectric conversion layer O_RL2. The first sensing anode electrode O_AE1 is directly connected to the sensor driving circuit O_SD through a contact hole.

Each of the sensors FX may further include a routing wiring RW for electrically connecting the first and second light receiving elements OPD1 and OPD2. The routing wiring RW is electrically connected to the first sensing anode electrode O_AE1 and the second sensing anode electrode O_AE2. According to an embodiment of the inventive concept, the routing wiring RW may be integrally provided together with the first sensing anode electrode O_AE1 and the second sensing anode electrode O_AE2.

The routing wiring RW, the first sensing anode electrode O_AE1, and the second sensing anode electrode O_AE2 may be disposed on the same layer as the anode electrodes R_AE, G1_AE, G2_AE, and B_AE. In this case, the routing wiring RW, the first sensing anode electrode O_AE1, and the second sensing anode electrode O_AE2 may include the same material as the anode electrodes R_AE, G1_AE, G2_AE, and B_AE, and may be provided through the same process as the anode electrodes R_AE, G1_AE, G2_AE, and B_AE.

The first and second light receiving elements OPD1 and OPD2 may be connected in parallel to the sensor driving circuit O_SD by the routing wiring RW. Accordingly, the first and second light receiving elements OPD1 and OPD2 may be simultaneously turned on or simultaneously turned off by the sensor driving circuit O_SD. The first light receiving element OPD1 connected to the sensor driving circuit O_SD may be referred to as a main light receiving element, and the second light receiving element OPD2 electrically connected to the first light receiving element OPD1 through the routing wiring RW may be referred to as a dummy light receiving element.

When k is four as in FIG. 4B, a light sensing unit LSUa may include four light receiving elements (hereinafter referred to as first to fourth light receiving elements OPD1, OPD2, OPD3, and OPD4). One of the first to fourth light receiving elements OPD1, OPD2, OPD3, and OPD4 (e.g., the third light receiving element OPD3) is connected to a sensor driving circuit O_SDa.

Each of sensors FX may further include three routing wirings (hereinafter referred to as first to third routing wirings RW1, RW2, and RW3) that electrically connect the first to fourth light receiving elements OPD1, OPD2, OPD3, and OPD4. The first routing wiring RW1 electrically connects two light receiving elements (that is, the first and third light receiving elements OPD1 and OPD3) adjacent to each other in a first direction DR1 among the four light receiving elements OPD1, OPD2, OPD3, and OPD4. The second routing wiring RW2 electrically connects two light receiving elements (that is, the first and second light receiving elements OPD1 and OPD2) adjacent to each other in a second direction DR2 among the four light receiving elements OPD1, OPD2, OPD3, and OPD4. The third routing wiring RW3 electrically connects two light receiving elements (that is, the third and fourth light receiving elements OPD3 and OPD4) adjacent to each other in the second direction DR2 among the four light receiving elements OPD1, OPD2, OPD3, and OPD4. The third light receiving element OPD3 directly connected to the sensor driving circuit O_SDa may be referred to as a main light receiving element, and the remaining first, second, and fourth light receiving elements OPD1, OPD2, and OPD4 may be referred to as dummy light receiving elements.

The first light receiving element OPD1 includes a first sensing anode electrode O_AE1 and a first photoelectric conversion layer O_RL1, and the second light receiving element OPD2 includes a second sensing anode electrode O_AE2 and a second photoelectric conversion layer O_RL2. The third light receiving element OPD3 includes a third sensing anode electrode O_AE3 and a third photoelectric conversion layer O_RL3, and the fourth light receiving element OPD4 includes a fourth sensing anode electrode O_AE4 and a fourth photoelectric conversion layer O_RL4. The third sensing anode electrode O_AE3 is directly connected to the sensor driving circuit O_SDa through a contact hole. In the first direction DR1, the sensor driving circuit O_SDa may have a length greater than those of red and blue pixel driving circuits R_PD and B_PD. Accordingly, when viewed in a plane, the sensor driving circuit O_SDa may be disposed to overlap two of the first to fourth light receiving elements OPD1 to OPD4 (e.g., the first and third light receiving elements OPD1 and OPD3). The sensor driving circuit O_SDa may overlap two green light emitting elements (e.g., first and second green light emitting elements ED_G1 and ED_G2) when viewed in a plane.

The first routing wiring RW1 is electrically connected to the first sensing anode electrode O_AE1 and the third sensing anode electrode O_AE3, and the second routing wiring RW2 is electrically connected to the first sensing anode electrode O_AE1 and the second sensing anode electrode O_AE2. The third routing wiring RW3 is electrically connected to the third sensing anode electrode O_AE3 and the fourth sensing anode electrode O_AE4. According to an embodiment of the inventive concept, the first to third routing wirings RW1 to RW3 may be integrally provided together with the first to fourth sensing anode electrodes O_AE1 to O_AE4.

The first to third routing wirings RW1 to RW3 and the first to fourth sensing anode electrodes O_AE1 to O_AE4 may be disposed on the same layer as anode electrodes R_AE, G1_AE, G2_AE, and B_AE. In this case, the first to third routing wirings RW1 to RW3 and the first to fourth sensing anode electrodes O_AE1 to O_AE4 may include the same material as the anode electrodes R_AE, G1_AE, G2_AE, and B_AE, and may be provided through the same process as the anode electrodes R_AE, G1_AE, G2_AE, and B_AE.

The first to fourth light receiving elements OPD1, OPD2, OPD3, and OPD4 may be connected in parallel to the sensor driving circuit O_SDa by the first to third routing wirings RW1, RW2, and RW3. Accordingly, the first to fourth light receiving elements OPD1, OPD2, OPD3, and OPD4 may be simultaneously turned on or simultaneously turned off by the sensor driving circuit O_SDa.

Each of the sensor driving circuits O_SD and O_SDa respectively illustrated in FIGS. 4A and 4B may include a plurality of transistors. According to an embodiment of the inventive concept, the sensor driving circuit O_SD and the pixel driving circuits R_PD, G1_PD, G2_PD, and B_PD may be simultaneously provided through the same process, and the sensor driving circuit O_SDa, the pixel driving circuits R_PD and B_PD, and pixel driving circuits G1_PD and G2_PD may be simultaneously provided through the same process. In addition, a scan driver 300 (see FIG. 3) may include transistors provided through a process the same as those of the sensor driving circuits O_SD and O_SDa and the pixel driving circuits R_PD, G1_PD, G2_PD, and B_PD.

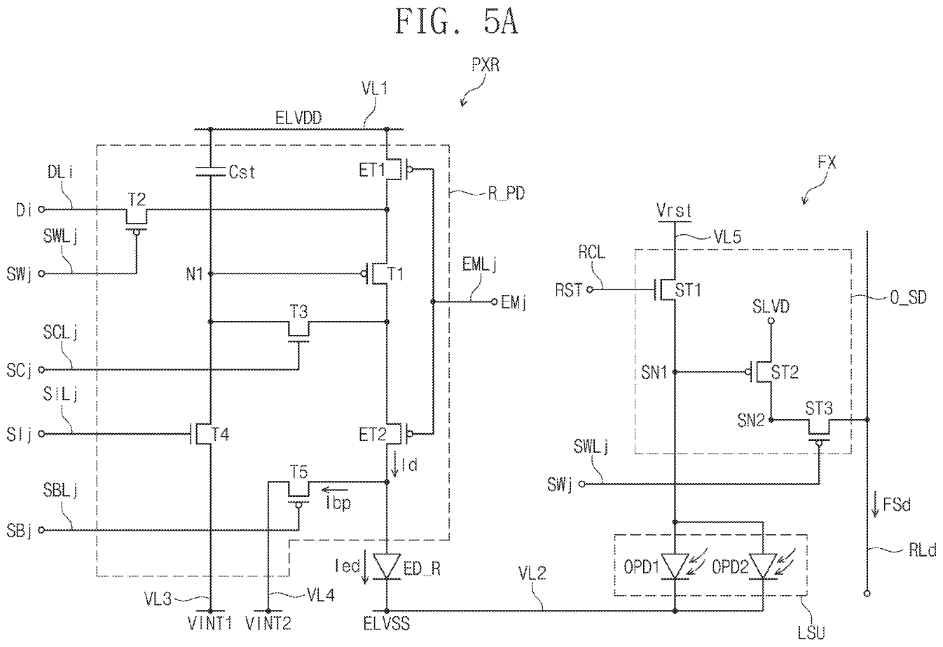

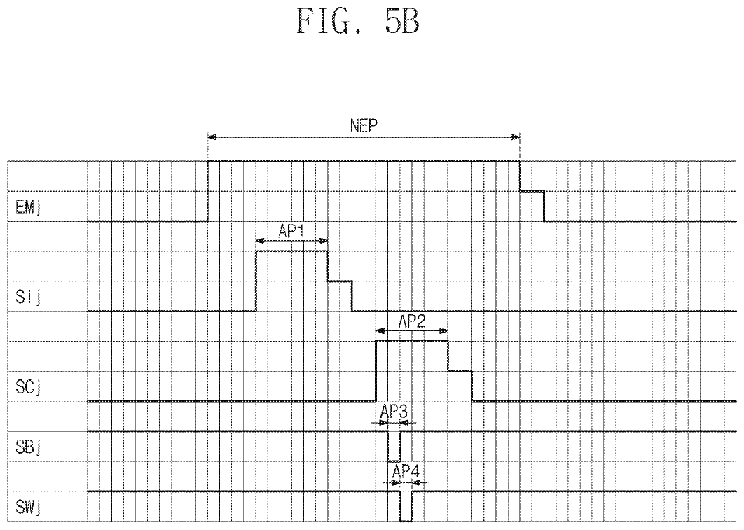

FIG. 5A is a circuit diagram illustrating one of pixels and a corresponding sensor according to an embodiment of the inventive concept FIG. 5B is a waveform diagram referred to when describing operations of the pixel and the sensor illustrated in FIG. 5A.

FIG. 5A illustrates, as an example, an equivalent circuit diagram of one pixel (e.g., the red pixel PXR) of the plurality of pixels PX illustrated in FIG. 3. Because the plurality of pixels PX have the same circuit configurations, for convenience of explanation, detailed descriptions of the remaining pixels other than a description of the circuit configuration of the red pixel PXR will not be given. In addition, an equivalent circuit diagram of one sensor FX of the plurality of sensors FX illustrated in FIG. 3 is illustrated as an example in FIG. 5A. Because the plurality of sensors FX have the same circuit configurations, for convenience of explanation, detailed descriptions of the remaining sensors other than a description of the circuit configuration of the sensor FX will not be given.

Referring to FIG. 5A, the red pixel PXR is connected to an i-th data line DLi of the data lines DL1 to DLm, a j-th initialization scan line SILj of the initialization scan lines SIL1 to SILn, a j-th compensation scan line SCLj of the compensation scan lines SCL1 to SCLn, a j-th write scan line SWLj of the write scan lines SWL1 to SWLn, a j-th black scan line SBLj of the black scan lines SBL1 to SBLn, and a j-th emission control line EMLj of the emission control lines EML1 to EMLn.

The red pixel PXR includes the red light emitting element ED_R and the red pixel driving circuit R_PD. The red light emitting element ED_R may be a light emitting diode. According to an embodiment of the inventive concept, the red light emitting element ED_R may be an organic light emitting diode including an organic light emitting layer.

The red pixel driving circuit R_PD includes first to fifth transistors T1, T2, T3, T4, and T5, first and second emission control transistors ET1 and ET2, and one capacitor Cst. At least one of the first to fifth transistors T1, T2, T3, T4, and T5 or the first and second emission control transistors ET1 and ET2 may be a transistor having a low-temperature polycrystalline silicon (LTPS) semiconductor layer. Some of the first to fifth transistors T1, T2, T3, T4, and T5 and the first and second emission control transistors ET1 and ET2 may be P-type transistors, and the rest thereof may be N-type transistors. For example, the first, second, and fifth transistors T1, T2, and T5 and the first and second emission control transistors ET1 and ET2 may be p-type metal-oxide semiconductor (PMOS) transistors, and the third and fourth transistors T3 and T4 may be n-type metal-oxide semiconductor (NMOS) transistors. At least one of the first to fifth transistors T1, T2, T3, T4, and T5 or the first and second emission control transistors ET1 and ET2 may be a transistor having an oxide semiconductor layer. For example, the third and fourth transistors T3 and T4 may be oxide semiconductor transistors, and the first, second, and fifth transistors T1, T2, and T5 and the first and second emission control transistors ET1 and ET2 may be low-temperature polycrystalline silicon (LTPS) transistors.

The configuration of the red pixel driving circuit R_PD according to an embodiment of the inventive concept is not limited to the configuration shown in FIG. 5A. The red pixel driving circuit R_PD illustrated in FIG. 5A is only an example, and the configuration of the red pixel driving circuit R_PD may be modified according to embodiments of the present inventive concept. For example, in an embodiment, all of the first to fifth transistors T1, T2, T3, T4, and T5 and the first and second emission control transistors ET1 and ET2 may be P-type transistors, or all thereof may be N-type transistors.

The j-th initialization scan line SILj, the j-th compensation scan line SCLj, the j-th write scan line SWLj, the j-th black scan line SBLj, and the j-th emission control line EMLj may respectively transmit, to the red pixel PXR, a j-th initialization scan signal SIj, a j-th compensation scan signal SCj, a j-th write scan signal SWj, a j-th black scan signal SBj, and a j-th emission control signal EMj. The i-th data line DLi transmits an i-th data signal Di to the red pixel PXR. The i-th data signal Di may have a voltage level corresponding to the image signal RGB (see FIG. 3) input to the display device DD (see FIG. 3).

First and second driving voltage lines VL1 and VL2 may respectively transmit the first driving voltage ELVDD and the second driving voltage ELVSS to the red pixel PXR. In addition, first and second initialization voltage lines VL3 and VL4 may respectively transmit the first initialization voltage VINT1 and the second initialization voltage VINT2 to the red pixel PXR.

The first transistor T1 is connected between the first driving voltage line VL1 that receives the first driving voltage ELVDD and the red light emitting element ED_R. The first transistor T1 includes a first electrode connected to the first driving voltage line VL1 via the first emission control transistor ET1, a second electrode connected to the red anode electrode R_AE (see FIG. 4A) of the red light emitting element ED_R via the second emission control transistor ET2, and a third electrode (e.g., a gate electrode) connected to one end of the capacitor Cst (e.g., a first node N1). The first transistor T1 may receive the i-th data signal Di transmitted from the i-th data line DLi according to the switching operation of the second transistor T2 and may supply a driving current Id to the red light emitting element ED_R.

The second transistor T2 is connected between the data line DLi and the first electrode of the first transistor T1. The second transistor T2 includes a first electrode connected to the i-th data line DLi, a second electrode connected to the first electrode of the first transistor T1, and a third electrode (e.g., a gate electrode) connected to the j-th write scan line SWLj. The second transistor T2 may be turned on according to the write scan signal SWj transmitted through the j-th write scan line SWLj to transmit, to the first electrode of the first transistor T1, the i-th data signal Di transmitted from the i-th data line DLi.

The third transistor T3 is connected between the second electrode of the first transistor T1 and the first node N1. The third transistor T3 includes a first electrode connected to the third electrode of the first transistor T1, a second electrode connected to the second electrode of the first transistor T1, and a third electrode (e.g., a gate electrode) connected to the j-th compensation scan line SCLj. The third transistor T3 may be turned on according to the j-th compensation scan signal SCj received through the j-th compensation scan line SCLj to connect the third electrode and the second electrode of the first transistor T1 to each other, and thus may allow the first transistor T1 to be diode-connected.

The fourth transistor T4 is connected between the first initialization voltage line VL3 to which the first initialization voltage VINT1 is applied and the first node N1. The fourth transistor T4 includes a first electrode connected to the first initialization voltage line VL3 to which the first initialization voltage VINT1 is transmitted, a second electrode connected to the first node N1, and a third electrode (e.g., a gate electrode) connected to the j-th initialization scan line SILj. The fourth transistor T4 is turned on according to the j-th initialization scan signal SIj received through the j-th initialization scan line SILj. The turned-on fourth transistor T4 transmits the first initialization voltage VINT1 to the first node N1 to initialize a potential of the third electrode of the first transistor T1 (e.g., a potential of the first node N1).

The first emission control transistor ET1 includes a first electrode connected to the first driving voltage line VL1, a second electrode connected to the first electrode of the first transistor T1, and a third electrode (e.g., a gate electrode) connected to the j-th emission control line EMLj.

The second emission control transistor ET2 includes a first electrode connected to the second electrode of the first transistor T1, a second electrode connected to the red anode electrode R_AE of the red light emitting element ED_R, and a third electrode (e.g., a gate electrode) connected to the j-th emission control line EMLj.

The first and second emission control transistors ET1 and ET2 are simultaneously turned on according to the j-th emission control signal EMj transmitted through the j-th emission control line EMLj. The first driving voltage ELVDD applied through the turned-on first emission control transistor ET1 may be compensated through the diode-connected first transistor T1 and then may be transmitted to the red light emitting element ED_R.

The fifth transistor T5 includes a first electrode connected to the second initialization voltage line VL4 to which the second initialization voltage VINT2 is transmitted, a second electrode connected to the second electrode of the second emission control transistor ET2, and a third electrode (e.g., a gate electrode) connected to the j-th black scan line SBLj. The second initialization voltage VINT2 may have a voltage level lower than or equal to that of the first initialization voltage VINT1. As described above, the one end of the capacitor Cst is connected to the third electrode of the first transistor T1, and the other end thereof is connected to the first driving voltage line VL1. A cathode electrode of the red light emitting element ED_R may be connected to the second driving voltage line VL2 that transmits the second driving voltage ELVSS. The second driving voltage ELVSS may have a voltage level lower than that of the first driving voltage ELVDD. According to an embodiment of the inventive concept, the second driving voltage ELVSS may have a voltage level lower than those of the first and second initialization voltages VINT1 and VINT2.

Referring to FIGS. 5A and 5B, the j-th emission control signal EMj has a high level during a non-emission period NEP. The j-th initialization scan signal SIj is activated in the non-emission period NEP. When a j-th initialization scan signal SIj of the high level is provided through the j-th initialization scan line SILj during an activation period AP1 (hereinafter referred to as a first activation period AP1) of the j-th initialization scan signal SIj, the fourth transistor T4 is turned on in response to the j-th initialization scan signal SIj of the high level. The first initialization voltage VINT1 is transmitted to the third electrode of the first transistor T1 through the turned-on fourth transistor T4, and the first node N1 is initialized to the first initialization voltage VINT1. Accordingly, the first activation period AP1 may be defined as an initialization period of the red pixel PXR.

Thereafter, the j-th compensation scan signal SCj is activated, and when a j-th compensation scan signal SCj of the high level is provided through the j-th compensation scan line SCLj during an activation period AP2 (hereinafter referred to as a second activation period AP2) of the j-th compensation scan signal SCj, the third transistor T3 is turned on. The first transistor T1 becomes diode-connected and forward biased by the turned-on third transistor T3. According to embodiments, the first activation period AP1 does not overlap the second activation period AP2.

The j-th write scan signal SWj is activated in the second activation period AP2. The j-th write scan signal SWj has a low level during an activation period AP4 (hereinafter referred to as a fourth activation period AP4). During the fourth activation period AP4, the second transistor T2 is turned on by the j-th write scan signal SWj of the low level. Then, a compensation voltage (e.g., “Di-Vth”), which is obtained by subtracting a threshold voltage Vth of the first transistor T1 from the i-th data signal Di provided from the i-th data line DLi, is applied to the third electrode of the first transistor T1. That is, the potential of the third electrode of the first transistor T1 may be the compensation voltage (e.g., “Di-Vth”). The fourth activation period AP4 may overlap the second activation period AP2. The duration of the second activation period AP2 may be longer than the duration of the fourth activation period AP4.

The first driving voltage ELVDD and the compensation voltage (“Di-Vth”) may be respectively applied to both ends of the capacitor Cst, and charges corresponding to a voltage difference between both ends may be stored in the capacitor Cst. Here, the period of the j-th compensation scan signal SCj of the high level may be referred to as a compensation period of the red pixel PXR.

According to an embodiment, the j-th black scan signal SBj is activated in the second activation period AP2 of the j-th compensation scan signal SCj. The j-th black scan signal SBj has the low level during an activation period AP3 (hereinafter referred to as a third activation period AP3). During the third activation period AP3, the fifth transistor T5 is turned on by receiving the j-th black scan signal SBj of the low level through the j-th black scan line SBLj. A portion of the driving current Id may escape as a bypass current Ibp through the fifth transistor T5 by the fifth transistor T5. The third activation period AP3 may overlap the second activation period AP2. The duration of the second activation period AP2 may be longer than the duration of the third activation period AP3. In an embodiment, the third activation period AP3 may precede the fourth activation period AP4 and does not overlap the fourth activation period AP4.

In a case in which the red pixel PXR displays a black image, when the red light emitting element ED_R emits light even when a minimum driving current of the first transistor T1 flows as the driving current Id, the red pixel PXR is incapable of normally displaying the black image. Accordingly, the fifth transistor T5 in the red pixel PXR according to an embodiment of the inventive concept may divert a portion of the minimum driving current of the first transistor T1, as the bypass current Ibp, to a current path other than a current path toward the red light emitting element ED_R. Here, the minimum driving current of the first transistor T1 refers to a current flowing through the first transistor T1 under a condition that the first transistor T1 is turned off because a gate-source voltage Vgs of the first transistor T1 is lower than the threshold voltage Vth thereof. In this way, under the condition that the first transistor T1 is turned off, the minimum driving current (e.g., a current of about 10 pA or less) flowing through the first transistor T1 is transmitted to the red light emitting element ED_R, and thus, an image of a black gradation is displayed. The effect of the bypass current Ibp on the minimum driving current may be relatively large when the red pixel PXR displays a black image, whereas the bypass current Ibp may have little effect on the driving current Id when the red pixel PXR displays an image such as a typical image and a white image. Accordingly, when a black image is displayed, a current (e.g., an emission current Ied) obtained by subtracting an amount of current of the bypass current Ibp escaping through the fifth transistor T5 from the driving current Id is provided to the red light emitting element ED_R. As a result, the black image may be accurately displayed. Accordingly, the red pixel PXR may implement an image of an accurate black gradation by using the fifth transistor T5, and as a result, the contrast ratio may be improved.

Thereafter, the j-th emission control signal EMj provided from the j-th emission control line EMLj transitions from the high level to the low level. The first and second emission control transistors ET1 and ET2 are turned on by the low-level emission control signal EMj. Then, the driving current Id according to a voltage difference between a voltage of the third electrode of the first transistor T1 and the first driving voltage ELVDD is generated, and the driving current Id is supplied to the red light emitting element ED_R through the second emission control transistor ET2, and thus, the current Ied flows through the red light emitting element ED_R.

Referring back to FIG. 5A, the sensor FX is connected to a d-th readout line RLd of the readout lines RL1 to RLh, the j-th write scan line SWLj, and a reset control line RCL.

The sensor FX includes the light sensing unit LSU and the sensor driving circuit O_SD. The light sensing unit LSU may include the k number of light receiving elements connected in parallel to each other. When k is two, the first and second light receiving elements OPD1 and OPD2 may be connected in parallel to each other. When k is four, first to fourth light receiving elements OPD1 to OPD4 (see FIG. 4B) may be connected in parallel to each other. Each of the first and second light receiving elements OPD1 and OPD2 may be a photodiode. According to an embodiment of the inventive concept, each of the first and second light receiving elements OPD1 and OPD2 may be an organic photodiode including an organic material included in the photoelectric conversion layer.

The first and second sensing anode electrodes O_AE1 and O_AE2 (see FIG. 4A) of the first and second light receiving elements OPD1 and OPD2 may be connected to a first sensing node SN1, and first and second sensing cathode electrodes of the first and second light receiving elements OPD1 and OPD2 may be connected to the second driving voltage line VL2 that transmits the second driving voltage ELVSS. The first and second sensing cathode electrodes may be electrically connected to the cathode electrode of the light emitting element ED_R (see FIG. 4A) and cathode electrodes of the light emitting elements ED_G1, ED_G2, and ED_B (see FIG. 4A). According to an embodiment of the inventive concept, the first and second sensing cathode electrodes may be integrally provided together with the cathode electrodes of the light emitting elements ED_R, ED_G1, ED_G2, and ED_B to define a common cathode electrode C_CE (see FIG. 6).

The sensor driving circuit O_SD includes three transistors ST1 to ST3. The three transistors ST1 to ST3 may be, for example, a reset transistor ST1, an amplification transistor ST2, and an output transistor ST3, respectively. At least one of the reset transistor ST1, the amplification transistor ST2, or the output transistor ST3 may be an oxide semiconductor transistor. According to an embodiment of the inventive concept, the reset transistor ST1 may be an oxide semiconductor transistor, and the amplification transistor ST2 and the output transistor ST3 may be LTPS transistors. However, embodiments of the inventive concept are not limited thereto. For example, according to an embodiment, at least the reset transistor ST1 and the output transistor ST3 may be oxide semiconductor transistors, and the amplification transistor ST2 may be an LTPS transistor.

In addition, some of the reset transistor ST1, the amplification transistor ST2, and the output transistor ST3 may be P-type transistors, and the rest thereof may be N-type transistors. According to an embodiment of the inventive concept, the amplification transistor ST2 and the output transistor ST3 may be PMOS transistors, and the reset transistor ST1 may be an NMOS transistor. However, embodiments of the inventive concept are not limited thereto. For example, according to an embodiment, all of the reset transistor ST1, the amplification transistor ST2, and the output transistor ST3 may be N-type transistors, or all thereof may be P-type transistors.

Some (e.g., the reset transistor ST1) of the reset transistor ST1, the amplification transistor ST2, and the output transistor ST3 may be transistors of a type the same as those of the third and fourth transistors T3 and T4 of the red pixel PXR. The amplification transistor ST2 and the output transistor ST3 may be transistors of a type the same as those of the first, second, and fifth transistors T1, T2, and T5 and the first and second emission control transistors ET1 and ET2 of the red pixel PXR.

A circuit configuration of the sensor driving circuit O_SD according to an embodiment of the inventive concept is not limited to the circuit configuration of FIG. 5A. That is, the sensor driving circuit O_SD illustrated in FIG. 5A is only an example, and the configuration of the sensor driving circuit O_SD may be modified according to embodiments.

The reset transistor ST1 includes a first electrode connected to a reset voltage line VL5 that receives a reset voltage Vrst, a second electrode connected to the first sensing node SN1, and a third electrode connected to the reset control line RCL that receives a reset control signal RST. The reset transistor ST1 may reset a potential of the first sensing node SN1 to the reset voltage Vrst in response to the reset control signal RST. The reset control signal RST may be a signal provided through the reset control line RCL. However, embodiments of the inventive concept are not limited thereto. Alternatively, the reset control signal RST may be the j-th compensation scan signal SCj provided through the j-th compensation scan line SCLj. That is, the reset transistor ST1 may receive the j-th compensation scan signal SCj provided from the j-th compensation scan line SCLj as the reset control signal RST. According to an embodiment of the inventive concept, the reset voltage Vrst may have a voltage level lower than that of the second driving voltage ELVSS during at least an activation period of the reset control signal RST. The reset voltage Vrst may be a DC voltage that is maintained at a voltage level lower than that of the second driving voltage ELVSS.

The reset transistor ST1 may include a plurality of sub-reset transistors connected in series. For example, the reset transistor ST1 may include two sub-reset transistors (hereinafter referred to as first and second sub-reset transistors). In this case, a third electrode of the first sub-reset transistor and a third electrode of the second sub-reset transistor are connected to the reset control line RCL. In addition, a second electrode of the first sub-reset transistor and a first electrode of the second sub-reset transistor may be electrically connected to each other. In addition, the reset voltage Vrst may be applied to a first electrode of the first sub-reset transistor, and a second electrode of the second sub-reset transistor may be electrically connected to the first sensing node SN1. However, the number of sub-reset transistors is not limited thereto and may be variously changed according to embodiments.

The amplification transistor ST2 includes a first electrode that receives a sensing driving voltage SLVD, a second electrode connected to a second sensing node SN2, and a third electrode connected to the first sensing node SN1. The amplification transistor ST2 may be turned on according to the potential of the first sensing node SN1 to apply the sensing driving voltage SLVD to the second sensing node SN2. According to an embodiment of the inventive concept, the sensing driving voltage SLVD may be one of the first driving voltage ELVDD and the first and second initialization voltages VINT1 and VINT2. In a case in which the sensing driving voltage SLVD is the first driving voltage ELVDD, the first electrode of the amplification transistor ST2 may be electrically connected to the first driving voltage line VL1. In a case in which the sensing driving voltage SLVD is the first initialization voltage VINT1, the first electrode of the amplification transistor ST2 may be electrically connected to the first initialization voltage line VL3. In a case in which the sensing driving voltage SLVD is the second initialization voltage VINT2, the first electrode of the amplification transistor ST2 may be electrically connected to the second initialization voltage line VL4.

The output transistor ST3 includes a first electrode connected to the second sensing node SN2, a second electrode connected to the d-th readout line RLd, and a third electrode that receives an output control signal. The output transistor ST3 may transmit a d-th readout signal FSd to the d-th readout line RLd in response to the output control signal. The output control signal may be the j-th write scan signal SWj provided through the j-th write scan line SWLj. That is, the output transistor ST3 may receive the j-th write scan signal SWj provided from the j-th write scan line SWLj as the output control signal.

The light sensing unit LSU of the sensor FX may be exposed to light during an emission period of the light emitting elements ED_R, ED_G1, ED_G2, and ED_B. The light may be light output from any one of the light emitting elements ED_R, ED_G1, ED_G2, and ED_B.

When the user's finger US_F (see FIG. 1) touches the display surface, the first and second light receiving elements OPD1 and OPD2 generate photocharges corresponding to light reflected by ridges of a fingerprint or by valleys between the ridges of the fingerprint. An amount of current flowing through the light receiving elements OPD1 and OPD2 is changed by the generated photocharges. When the light receiving elements OPD1 and OPD2 receive light reflected by the ridges of the fingerprint, the current flowing through the light receiving elements OPD1 and OPD2 may be referred to as a first current, and when the light receiving elements OPD1 and OPD2 receive light reflected by the valleys of the fingerprint, the current flowing through the light receiving elements OPD1 and OPD2 may be referred to as a second current. Because amounts of light are different between the light reflected by the ridges of the fingerprint and the light reflected by the valleys of the fingerprint, a difference between the amounts of light appears as a difference between the first and second currents. When the first current flows through the light receiving elements OPD1 and OPD2, the potential of the first sensing node SN1 may be referred to as a first potential, and when the second current flows through the light receiving elements OPD1 and OPD2, the potential of the first sensing node SN1 may be referred to as a second potential. According to an embodiment of the inventive concept, the first current may be higher than the second current, and in this case, the first potential may be lower than the second potential.

The amplification transistor ST2 may be a source follower amplifier that generates a source-drain current in proportion to the potential of the first sensing node SN1 input to the third electrode.

During the fourth activation period AP4, the j-th write scan signal SWj of the low level is provided to the output transistor ST3 through the j-th write scan line SWLj. When the output transistor ST3 is turned on in response to the j-th write scan signal SWj of the low level, the d-th readout signal FSd corresponding to a current flowing through the amplification transistor ST2 may be output to the d-th readout line RLd.

Thereafter, the reset transistor ST1 is turned on when a reset control signal RST of the high level is provided to the reset transistor ST1 through the reset control line RCL during a reset period. The reset period may be defined as an activation period (e.g., a high level period) of the reset control line RCL. Alternatively, when the reset transistor ST1 is a PMOS transistor, a reset control signal RST of the low level may be provided to the reset control line RCL during the reset period. During the reset period, the first sensing node SN1 may be reset to a potential corresponding to the reset voltage Vrst. According to an embodiment of the inventive concept, the reset voltage Vrst may have a voltage level lower than that of the second driving voltage ELVSS.

Thereafter, when the reset period ends, the light sensing unit LSU may generate photocharges corresponding to the received light, and the generated photocharges may be accumulated in the first sensing node SN1.

FIG. 6 is a cross-sectional view illustrating one of pixels and a corresponding sensor of a display panel according to an embodiment of the inventive concept.

Referring to FIG. 6, the display panel DP (see FIG. 3) may include the base layer BL, the circuit layer DP_CL, and the element layer DP_ED.

The base layer BL may include a synthetic resin layer. The synthetic resin layer may include thermosetting resin. For example, the synthetic resin layer may be a polyimide-based resin layer, and the material thereof is not particularly limited. The synthetic resin layer may include at least one of, for example, acrylate-based resin, methacrylate-based resin, polyisoprene, vinyl-based resin, epoxy-based resin, urethane-based resin, cellulose-based resin, siloxane-based resin, polyamide-based resin, or perylene-based resin. In addition, the base layer BL may include, for example, a glass substrate, a metal substrate, an organic/inorganic composite material substrate, or the like.

At least one inorganic layer is provided on a top surface of the base layer BL. The inorganic layer may include at least one of, for example, aluminum oxide, titanium oxide, silicon oxide, silicon oxynitride, zirconium oxide, or hafnium oxide. The inorganic layer may be provided in multiple inorganic layers. The multiple inorganic layers may constitute a barrier layer BRL and/or a buffer layer BFL to be described below. The barrier layer BRL and the buffer layer BFL may be selectively disposed.

The circuit layer DP_CL may include the barrier layer BRL and/or the buffer layer BFL. The barrier layer BRL may prevent foreign matter from being introduced from outside of the display device DD. The barrier layer BRL may include, for example, a silicon oxide layer and a silicon nitride layer. Each of the silicon oxide layer and the silicon nitride layer may be provided in plurality, and the silicon oxide layers and the silicon nitride layers may be alternately laminated.

The buffer layer BFL may be disposed on the barrier layer BRL. The buffer layer BFL may increase the bonding force between the base layer BL and a semiconductor pattern and/or a conductive pattern. The buffer layer BFL may include, for example, a silicon oxide layer and a silicon nitride layer. The silicon oxide layer and the silicon nitride layer may be alternately laminated.

The semiconductor pattern is disposed on the buffer layer BFL. Hereinafter, the semiconductor pattern directly disposed on the buffer layer BFL is defined as a first semiconductor pattern. The first semiconductor pattern may include a silicon semiconductor. The first semiconductor pattern may include polysilicon. However, the first semiconductor pattern is not limited thereto and may also include, for example, amorphous silicon.

For convenience of illustration, only a portion of the first semiconductor pattern is illustrated in FIG. 6. According to an embodiment, another portion of the first semiconductor pattern may be further disposed in another area of the red pixel PXR (see FIG. 5A). The first semiconductor pattern has different electrical properties depending on whether the first semiconductor pattern is doped. The first semiconductor pattern may include a doped region and a non-doped region. The doped region may be doped with an N-type dopant or a P-type dopant. A P-type transistor includes a doped region doped with the P-type dopant, and an N-type transistor includes a doped region doped with the N-type dopant.

The conductivity of the doped region is higher than the conductivity of the non-doped region, and the doped region substantially serves as an electrode or a signal line. The non-doped region substantially corresponds to an active (or a channel) of the transistor. In other words, a portion of the first semiconductor pattern may be the active of the transistor, another portion may be a source or a drain of the transistor, and another portion may be a connection signal line (or a connection electrode).

As illustrated in FIG. 6, a first electrode Si, a channel portion A1, and a second electrode D1 of the first transistor T1 are provided from the first semiconductor pattern. The first electrode S1 and the second electrode D1 of the first transistor T1 extend in opposite directions from the channel portion A1.

FIG. 6 illustrates a portion of a connection signal line CSL provided from the first semiconductor pattern. In an embodiment, the connection signal line CSL may be connected to the second electrode of the second emission control transistor ET2 (see FIG. 5A) when viewed in a plane.

A first insulating layer 10 is disposed on the buffer layer BFL. The first insulating layer 10 overlaps the plurality of pixels PX (see FIG. 3) in common and covers the first semiconductor pattern. The first insulating layer 10 may be an inorganic layer and/or an organic layer and may have a single-layer structure or a multilayer structure. The first insulating layer 10 may include at least one of, for example, aluminum oxide, titanium oxide, silicon oxide, silicon oxynitride, zirconium oxide, or hafnium oxide. In an embodiment, the first insulating layer 10 may be a single-layer silicon oxide layer. In addition to the first insulating layer 10, an insulating layer of the circuit layer DP_CL to be described below may be an inorganic layer and/or an organic layer and may have a single-layer structure or a multilayer structure. The inorganic layer may include at least one of the above-described materials.

A third electrode G1 of the first transistor T1 is disposed on the first insulating layer 10. The third electrode G1 may be a portion of a metal pattern. The third electrode G1 of the first transistor T1 overlaps the channel portion A1 of the first transistor T1. In the process of doping the first semiconductor pattern, the third electrode G1 of the first transistor T1 may serve as a mask.

A second insulating layer 20 covering the third electrode G1 is disposed on the first insulating layer 10. The second insulating layer 20 overlaps the plurality of pixels PX in common. The second insulating layer 20 may be an inorganic layer and/or an organic layer and may have a single-layer structure or a multilayer structure. In an embodiment, the second insulating layer 20 may be a single-layer silicon oxide layer.

An upper electrode UE may be disposed on the second insulating layer 20. The upper electrode UE may overlap the third electrode G1. The upper electrode UE may be a portion of a metal pattern or a portion of a doped semiconductor pattern. A portion of the third electrode G1 and the upper electrode UE overlapping the portion may define the capacitor Cst (see FIG. 5A). In an embodiment of the inventive concept, the upper electrode UE may be omitted.

In an embodiment of the inventive concept, the second insulating layer 20 may be replaced with an insulating pattern. The upper electrode UE is disposed on the insulating pattern. The upper electrode UE may serve as a mask for providing the insulating pattern from the second insulating layer 20.

A third insulating layer 30 covering the upper electrode UE is disposed on the second insulating layer 20. In an embodiment, the third insulating layer 30 may be a single-layer silicon oxide layer. A semiconductor pattern is disposed on the third insulating layer 30. Hereinafter, the semiconductor pattern directly disposed on the third insulating layer 30 is defined as a second semiconductor pattern. The second semiconductor pattern may include metal oxide. An oxide semiconductor may include a crystalline or amorphous oxide semiconductor. For example, the oxide semiconductor may include oxide of a metal such as zinc (Zn), indium (In), gallium (Ga), tin (Sn), and titanium (T1), or a mixture of a metal such as zinc (Zn), indium (In), gallium (Ga), tin (Sn), and titanium (T1) and oxide thereof. The oxide semiconductor may include for example, indium-tin oxide (ITO), indium-gallium-zinc oxide (IGZO), zinc oxide (ZnO), indium-zinc oxide (IZO), zinc-indium oxide (ZIO), indium oxide (InO), titanium oxide (TiO), indium-zinc-tin oxide (IZTO), zinc-tin oxide (ZTO), and the like.

For convenience of illustration, FIG. 6 illustrates only a portion of the second semiconductor pattern. In an embodiment, another portion of the second semiconductor pattern may be further disposed in another area of the sensor FX. The second semiconductor pattern may include a plurality of regions divided according to whether the metal oxide is reduced. A region in which the metal oxide is reduced (hereinafter referred to as a reduction region) has a higher conductivity than a region in which the metal oxide is not reduced (hereinafter referred to as a non-reduction region). The reduction region has substantially the function of an electrode or a signal line. The non-reduction region substantially corresponds to a channel portion of the transistor. In other words, a portion of the second semiconductor pattern may be the channel portion of the transistor, and another portion may be the first electrode or the second electrode of the transistor.

As illustrated in FIG. 6, a first electrode S3, a channel portion A3, and a second electrode D3 of the third transistor T3 are provided from the second semiconductor pattern. The first electrode S3 and the second electrode D3 of the third transistor T3 extend in opposite directions from the channel portion A3.

The circuit layer DP_CL may further include a portion of semiconductor patterns of the sensor driving circuit O_SD (see FIG. 5A). The reset transistor ST1 of the semiconductor patterns of the sensor driving circuit O_SD is illustrated for convenience of illustration. A first electrode STS1, a channel portion STA1, and a second electrode STD1 of the reset transistor ST1 are provided from the second semiconductor pattern. According to an embodiment of the inventive concept, the second semiconductor pattern may include metal oxide. The first electrode STS1 and the second electrode STD1 include a metal reduced from the metal oxide semiconductor. The first electrode STS1 and the second electrode STD1 may have a predetermined thickness from a top surface of the second semiconductor pattern and may include a metal layer having the reduced metal.

A fourth insulating layer 40 covers the first electrode STS1, the channel portion STA1, and the second electrode STD1 of the reset transistor ST1. A third electrode G3 of the third transistor T3 and a third electrode STG1 of the reset transistor ST1 is disposed on the fourth insulating layer 40. In an embodiment, the third electrode STG1 may be a portion of a metal pattern. The third electrode STG1 of the reset transistor ST1 overlaps the channel portion STA1 of the reset transistor ST1. One third electrode STG1 is illustrated for convenience of illustration, but embodiments are not limited thereto. For example, in an embodiment, the reset transistor ST1 may include two third electrodes.

A fifth insulating layer 50 covering the third electrode G3 of the third transistor T3 and the third electrode STG1 of the reset transistor ST1 is disposed on the fourth insulating layer 40. In an embodiment, the fifth insulating layer 50 may include a silicon oxide layer and a silicon nitride layer. The fifth insulating layer 50 may include a plurality of silicon oxide layers and silicon nitride layers alternately laminated.

At least one insulating layer is further disposed on the fifth insulating layer 50. In an embodiment, a sixth insulating layer 60 and a seventh insulating layer may be disposed on the fifth insulating layer 50. Each of the sixth and seventh insulating layers 60 and 70 may be an organic layer and may have a single-layer structure or a multilayer structure. Each of the sixth and seventh insulating layers 60 and 70 may be a single-layer polyimide-based resin layer. Each of the sixth and seventh insulating layers 60 and 70 is not limited thereto and may include at least one of, for example, acrylate-based resin, methacrylate-based resin, polyisoprene, vinyl-based resin, epoxy-based resin, urethane-based resin, cellulose-based resin, siloxane-based resin, polyamide-based resin, or perylene-based resin.

A first connection electrode CNE10 may be disposed on the fifth insulating layer 50. The first connection electrode CNE10 may be connected to the connection signal line CSL through a first contact hole CH1 penetrating the first to fifth insulating layers 10 to 50, and a second connection electrode CNE20 may be connected to the first connection electrode CNE10 through a second contact hole CH2 penetrating the sixth insulating layer 60. In an embodiment of the inventive concept, at least one of the fifth insulating layer 50 to the seventh insulating layer 70 may be omitted, and one of the first and second connection electrodes CNE10 and CNE20 may also be omitted.

A third connection electrode CNE11 may be further disposed on the fifth insulating layer 50. The third connection electrode CNE11 may be connected to the second electrode STD1 of the reset transistor ST1 through a third contact hole CH3 penetrating the fourth and fifth insulating layers 40 and 50, and a fourth connection electrode CNE21 may be connected to the third connection electrode CNE11 through a fourth contact hole CH4 penetrating the sixth insulating layer 60.

The data line DLi (see FIG. 5A) and the readout line RLd may be disposed on the same layer (e.g., the sixth insulating layer 60) as the second and fourth connection electrodes CNE20 and CNE21. However, embodiments of the inventive concept are not limited thereto. Alternatively, the data line DLi (see FIG. 5A) and the readout line RLd may be disposed on the same layer (e.g., the fifth insulating layer 50) as the first and third connection electrodes CNE10 and CNE11. The second and fourth connection electrodes CNE20 and CNE21, the data line DLi, and the readout line RLd are covered by the seventh insulating layer 70.

The element layer DP_ED is disposed on the circuit layer DP_CL. The element layer DP_ED may include the red anode electrode R_AE of the red light emitting element ED_R (see FIG. 4A) and the first sensing anode electrode O_AE1 of the first light receiving element OPD1 (see FIG. 4A). As illustrated in FIG. 6, the red anode electrode R_AE may be connected to a first dummy connection electrode CNE30 through a seventh contact hole CH7 penetrating an eighth insulating layer 80. The first sensing anode electrode O_AE1 may be connected to a second dummy connection electrode CNE31 through an eighth contact hole CH8 penetrating the eighth insulating layer 80.

The element layer DP_ED further includes a pixel defining film PDL disposed on the circuit layer DP_CL. The pixel defining film PDL may include a light emitting opening OP1 defined to correspond to the red light emitting element ED_R and a light receiving opening OP2 defined to correspond to the first light receiving element OPD1. The light emitting opening OP1 exposes at least a portion of the red anode electrode R_AE of the red light emitting element ED_R. The light emitting opening OP1 of the pixel defining film PDL may define a light emitting area PXA. For example, the plurality of pixels PX (see FIG. 3) may be arranged on a plane of the display panel DP (see FIG. 3) according to a certain rule. An area in which the plurality of pixels PX are arranged may be defined as pixel areas, and each of the pixel areas may include the light emitting area PXA and a non-light emitting area NPXA adjacent to the light emitting area PXA. The non-light emitting area NPXA may surround the light emitting area PXA.

The light receiving opening OP2 exposes the first sensing anode electrode O_AE1 of the first light receiving element OPD1. The light receiving opening OP2 of the pixel defining film PDL may define a light receiving area SA. For example, the plurality of sensors FX (see FIG. 3) may be arranged on the plane of the display panel DP according to a certain rule. An area in which the plurality of sensors FX are arranged may be defined as sensing areas, and each of the sensing areas may include the light receiving area SA and a non-light receiving area NSA adjacent to the light receiving area SA. The non-light receiving area NSA may surround the light receiving area SA.

The red light emitting layer R_EL is disposed to correspond to the light emitting opening OP1 defined in the pixel defining film PDL, and the first photoelectric conversion layer O_RL1 is provided to correspond to the light receiving opening OP2 defined in the pixel defining film PDL. Although the patterned red light emitting layer R_EL is illustrated as an example, embodiments of the inventive concept are not limited thereto. A common light emitting layer may be disposed in common in the plurality of pixels PX. In this case, the common light emitting layer may generate white light or blue light. The common cathode electrode C_CE is connected in common to the light emitting element ED_R and the light receiving element OPD1. The common cathode electrode C_CE may face the sensing anode electrode O_AE1 and the red anode electrode R_AE. The common cathode electrode C_CE is disposed on the red light emitting layer R_EL and the first photoelectric conversion layer O_RL1. The common cathode electrode C_CE is disposed in common in the plurality of pixels PX and the plurality of sensors FX.

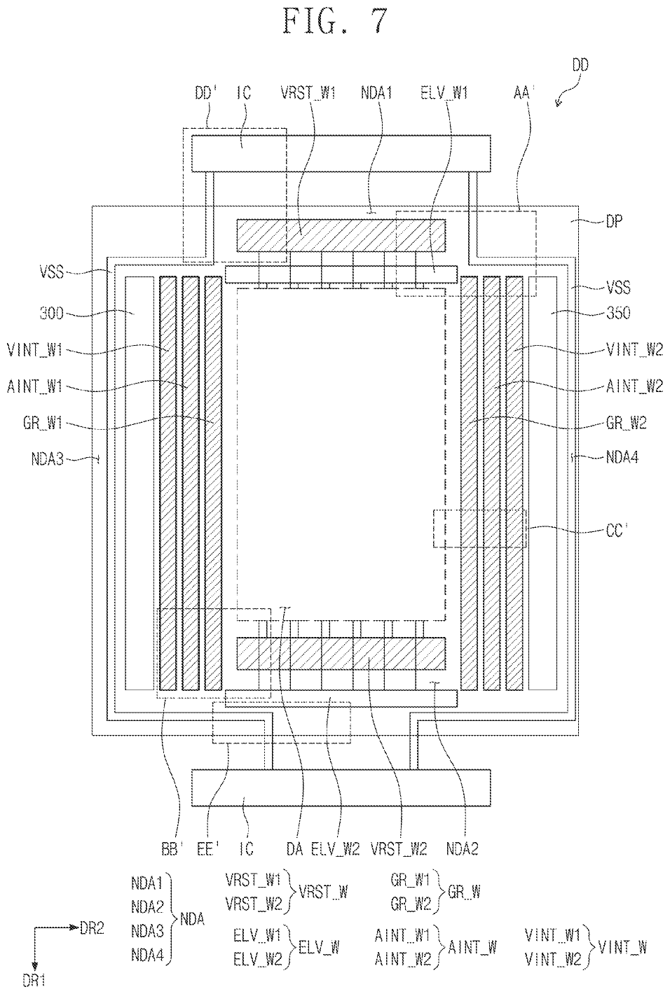

FIG. 7 is a plan view of a display device according to an embodiment of the inventive concept.

Referring to FIG. 7, the display device DD may include the display panel DP, and the active area DA and the peripheral area NDA may be defined in the display panel DP. The peripheral area NDA includes a first peripheral area NDA1, a second peripheral area NDA2, a third peripheral area NDA3, and a fourth peripheral area NDA4. The first peripheral area NDA1 is disposed on an upper side of the active area DA in the first direction DR1, and the second peripheral area NDA2 is disposed on a lower side of the active area DA in the first direction DR1. The third peripheral area NDA3 may be disposed on one side (e.g., a left side) of the active area DA in the second direction DR2, and the fourth peripheral area NDA4 may be disposed on the other side (e.g., a right side) of the active area DA in the second direction DR2.

The element layer DP_ED of the active area DA of the display panel DP has been described with reference to FIGS. 4A to 6, and for convenience of explanation, a further detailed description thereof will be omitted.

The circuit layer DP_CL (see FIG. 6) of the display panel DP may include a reset voltage reinforcement wiring VRST_W, a driving voltage wiring ELV_W, a third driving voltage wiring VSS, a reset control reinforcement wiring GR_W, a first initialization voltage reinforcement wiring VINT_W, and a second initialization voltage reinforcement wiring AINT_W.

The reset voltage reinforcement wiring VRST_W may be disposed in the peripheral area NDA of the display panel DP. The reset voltage reinforcement wiring VRST_W may include a first reset voltage reinforcement wiring VRST_W1 and a second reset voltage reinforcement wiring VRST_W2. The first reset voltage reinforcement wiring VRST_W1 may be disposed in the first peripheral area NDA1, and the second reset voltage reinforcement wiring VRST_W2 may be disposed in the second peripheral area NDA2. The reset voltage reinforcement wiring VRST_W may be connected to a plurality of reset voltage wirings disposed in the active area DA. Each of the first and second reset voltage reinforcement wirings VRST_W1 and VRST_W2 may be a bar-shaped wiring extending in the second direction DR2.

In an embodiment, the display panel DP may drive the pixels PX (see FIG. 3) and the sensors FX (see FIG. 3) with uniform performance regardless of their positions throughout the active area DA, by including the reset voltage reinforcement wiring VRST_W disposed in the peripheral area NDA. For example, the reset voltage reinforcement wiring VRST_W may allow uniform sensing performance to be secured by reducing a voltage drop of the reset voltage Vrst (see FIG. 5A) provided to the sensors FX.

In an embodiment, the display panel DP may include the driving voltage wiring ELV_W disposed in the peripheral area NDA. The driving voltage wiring ELV_W may be a wiring to which the first driving voltage ELVDD (see FIG. 5A) is provided. The driving voltage wiring ELV_W may include a first driving voltage wiring ELV_W1 disposed in the first peripheral area NDA1 and a second driving voltage wiring ELV_W2 disposed in the second peripheral area NDA2. The first driving voltage wiring ELV_W1 may be disposed closer to the active area DA than the first reset voltage reinforcement wiring VRST_W1 is disposed. The first driving voltage wiring ELV_W1 includes a portion extending to the active area DA and a portion disposed in the peripheral area NDA. For convenience of illustration, the portion disposed in the peripheral area NDA is illustrated in FIG. 7. The first driving voltage wiring ELV_W1 may be disposed to surround the active area DA. That is, in an embodiment, the first driving voltage wiring ELV_W1 may be disposed not only in the first peripheral area NDA1, but also in the second peripheral area NDA2.

The reset voltage reinforcement wiring VRST_W may be disposed farther from the active area DA than the first driving voltage wiring ELV_W1. That is, in the first peripheral area NDA1, the first reset voltage reinforcement wiring VRST_W1 may be disposed farther from the active area DA than the first driving voltage wiring ELV_W1. The first reset voltage reinforcement wiring VRST_W1 is disposed farther from the active area DA than the first driving voltage wiring ELV_W1. As a result, overlap of signals between the wirings may be minimized or reduced.

The second driving voltage wiring ELV_W2 may be electrically connected to the first driving voltage wiring ELV_W1. The second driving voltage wiring ELV_W2 may be disposed farther from the active area DA than the second reset voltage reinforcement wiring VRST_W2. Accordingly, the pixels PX and the sensors FX may operate with uniform performance regardless of their positions in the active area DA.

The second driving voltage ELVSS may be provided to the third driving voltage wiring VSS. The third driving voltage wiring VSS may be disposed farther from the active area DA than the first and second driving voltage wirings ELV_W1 and ELV_W2 and the reset voltage reinforcement wiring VRST_W. The third driving voltage wiring VSS may be connected to a panel driver IC. For example, the third driving voltage wiring VSS may be connected to the voltage generator 400 (see FIG. 3). The third driving voltage wiring VSS may extend at an outermost portion of the peripheral area NDA.

The reset control reinforcement wiring GR_W, the first initialization voltage reinforcement wiring VINT_W, and the second initialization voltage reinforcement wiring AINT_W may be disposed in the third peripheral area NDA3 and the fourth peripheral area NDA4. Each of the reset control reinforcement wiring GR_W, the first initialization voltage reinforcement wiring VINT_W, and the second initialization voltage reinforcement wiring AINT_W may be a bar-shaped wiring extending in the first direction DR1.

The reset control reinforcement wiring GR_W may include a first reset control reinforcement wiring GR_W1 disposed in the third peripheral area NDA3 and a second reset control reinforcement wiring GR_W2 disposed in the fourth peripheral area NDA4. The first reset control reinforcement wiring GR_W1 and the second reset control reinforcement wiring GR_W2 are spaced apart from each other in the second direction DR2 with the active area DA interposed therebetween.

The first initialization voltage reinforcement wiring VINT_W may include a first-first initialization voltage reinforcement wiring VINT_W1 disposed in the third peripheral area NDA3 and a first-second initialization voltage reinforcement wiring VINT_W2 disposed in the fourth peripheral area NDA4. The first-first initialization voltage reinforcement wiring VINT_W1 and the first-second initialization voltage reinforcement wiring VINT_W2 are spaced apart from each other in the second direction DR2 with the active area DA interposed therebetween.

The second initialization voltage reinforcement wiring AINT_W may include a second-first initialization voltage reinforcement wiring AINT_W1 disposed in the third peripheral area NDA3 and a second-second initialization voltage reinforcement wiring AINT_W2 disposed in the fourth peripheral area NDA4. The second-first initialization voltage reinforcement wiring AINT_W1 and the second-second initialization voltage reinforcement wiring AINT_W2 are spaced apart from each other in the second direction DR2 with the active area DA interposed therebetween.

The reset control reinforcement wiring GR_W, the first initialization voltage reinforcement wiring VINT_W, and the second initialization voltage reinforcement wiring AINT_W may be arranged in the second direction DR2. The reset control reinforcement wiring GR_W may be disposed closer to the active area DA than the first and second initialization voltage reinforcement wirings VINT_W and AINT_W. The first initialization voltage reinforcement wiring VINT_W may be disposed farther from the active area DA than the second initialization voltage reinforcement wiring AINT_W and the reset control reinforcement wiring GR_W. The second initialization voltage reinforcement wiring AINT_W may be disposed between the reset control reinforcement wiring GR_W and the first initialization voltage reinforcement wiring VINT_W.

The reset control reinforcement wiring GR_W may be electrically connected to reset control wirings of the active area DA. The reset control wirings may correspond to the reset control line RCL of FIG. 5A. The reset control reinforcement wiring GR_W may minimize or reduce a load difference between upper and lower portions of the display panel DP so that all reset transistors ST1 (see FIG. of the active area DA may be simultaneously turned on or turned off. That is, the reset control reinforcement wiring GR_W may allow the reset voltage Vrst to be applied substantially uniformly to each of the sensor driving circuits O_SD (see FIG. 4A) in the entirety of the active area DA.

The first initialization voltage reinforcement wiring VINT_W may be connected to first initialization voltage wirings of the active area DA. The first initialization voltage wirings may correspond to the first initialization voltage line VL3 of FIG. 5A.

The second initialization voltage reinforcement wiring AINT_W may be connected to second initialization voltage wirings of the active area DA. The second initialization voltage wirings may correspond to the second initialization voltage line VL4 of FIG. 5A.

The reset control reinforcement wiring GR_W, the first initialization voltage reinforcement wiring VINT_W, and the second initialization voltage reinforcement wiring AINT_W may be disposed closer to the active area DA than the scan driver 300 and the emission driver 350. Here, the emission driver 350 may be replaced with the scan driver 300. The circuit layer DP_CL of the display panel DP, which is disposed in the active area DA and the peripheral area NDA, will be described below.

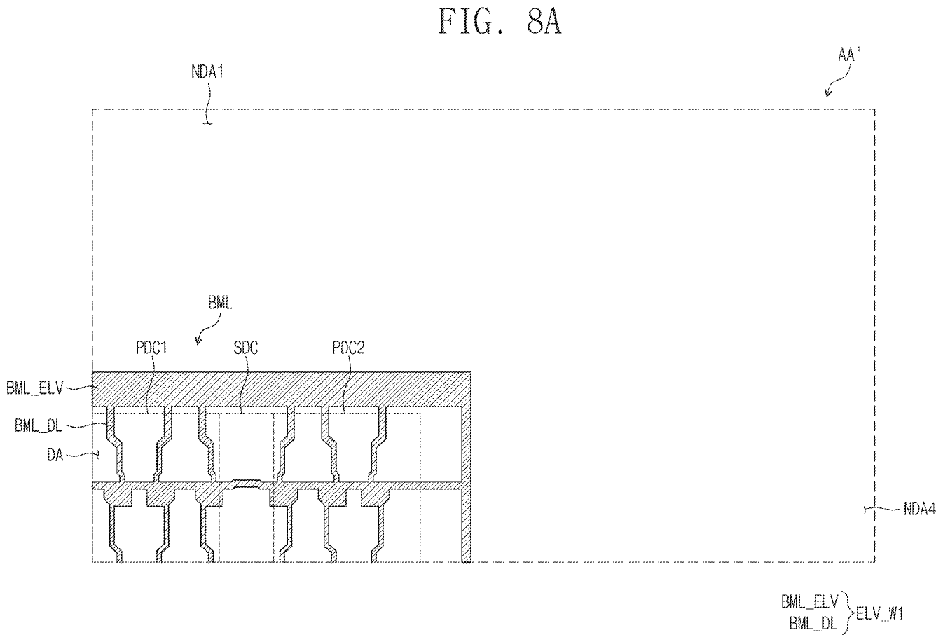

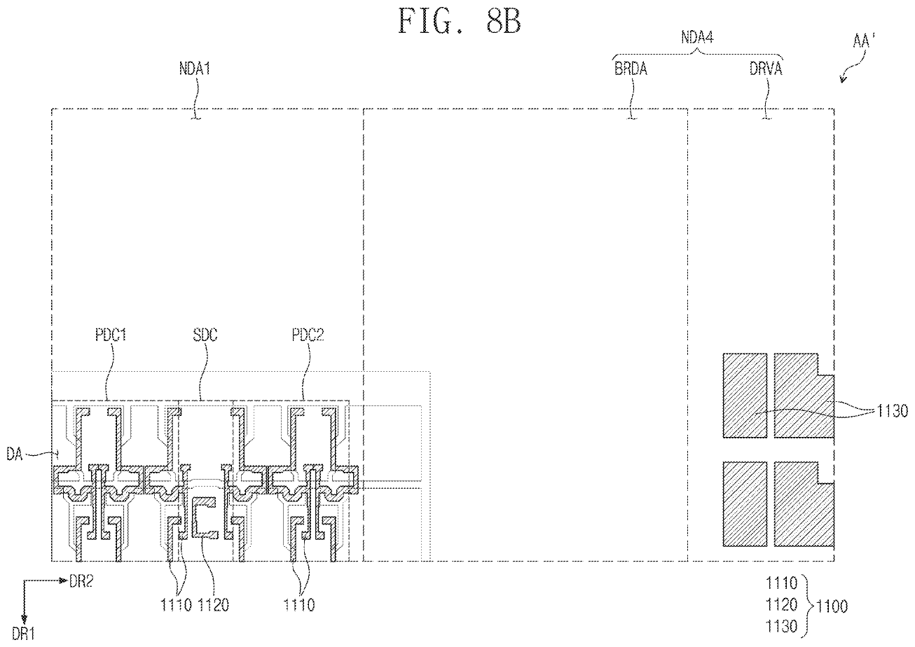

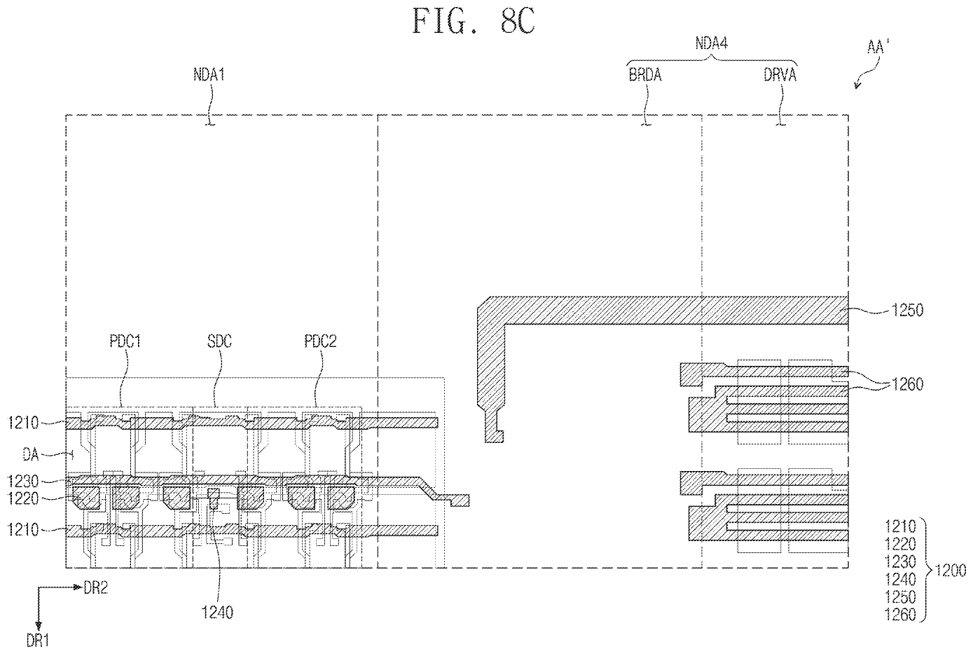

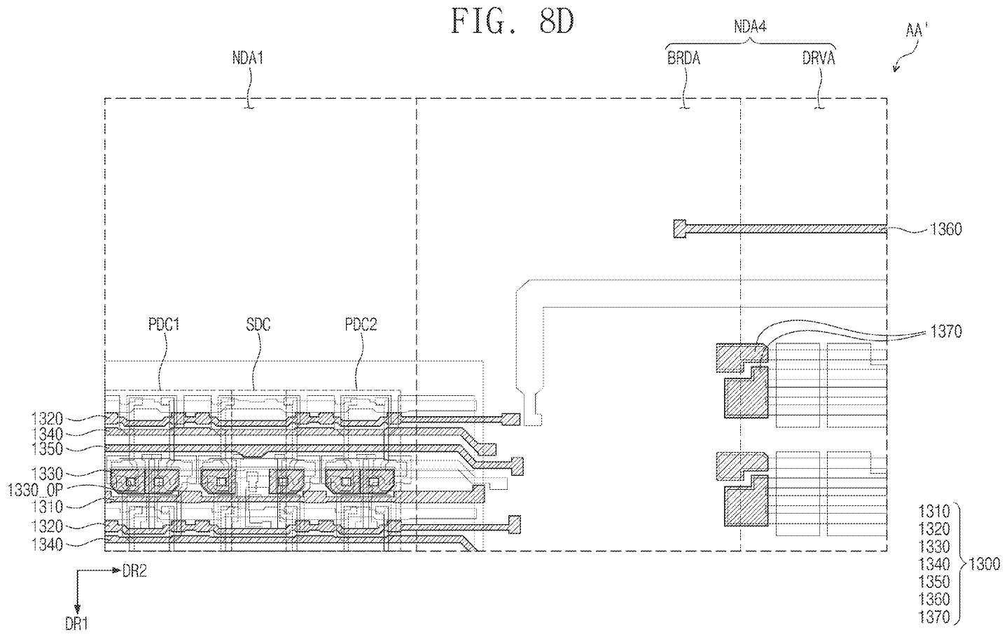

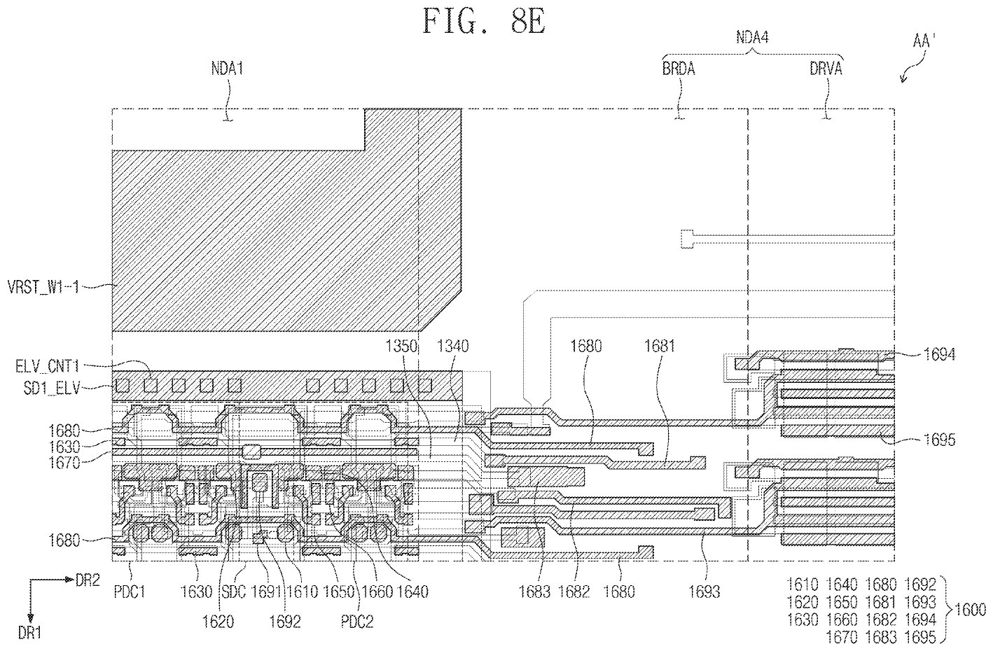

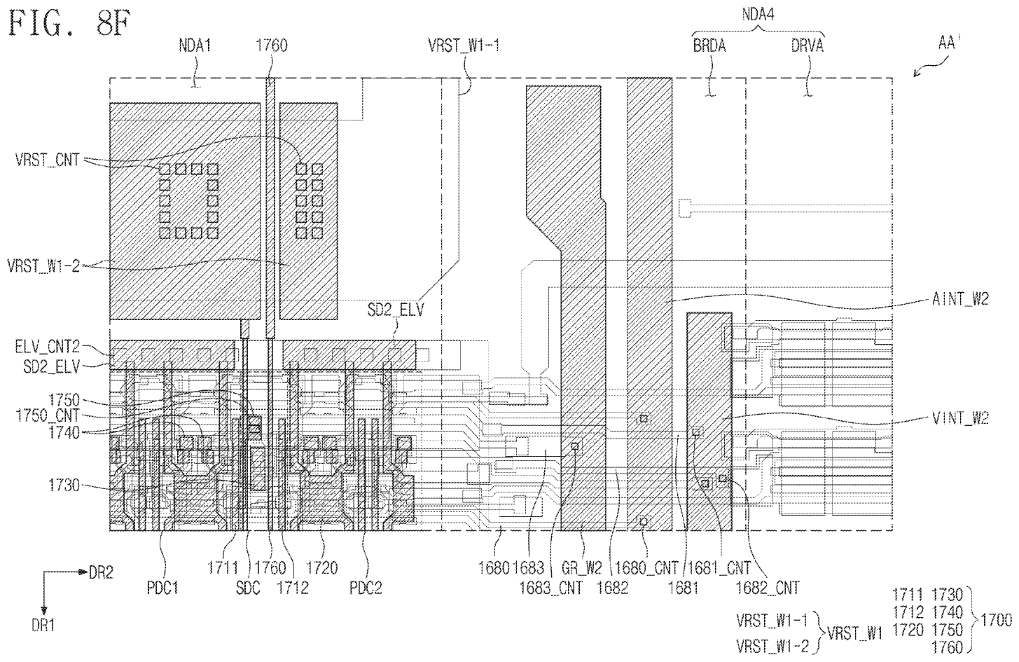

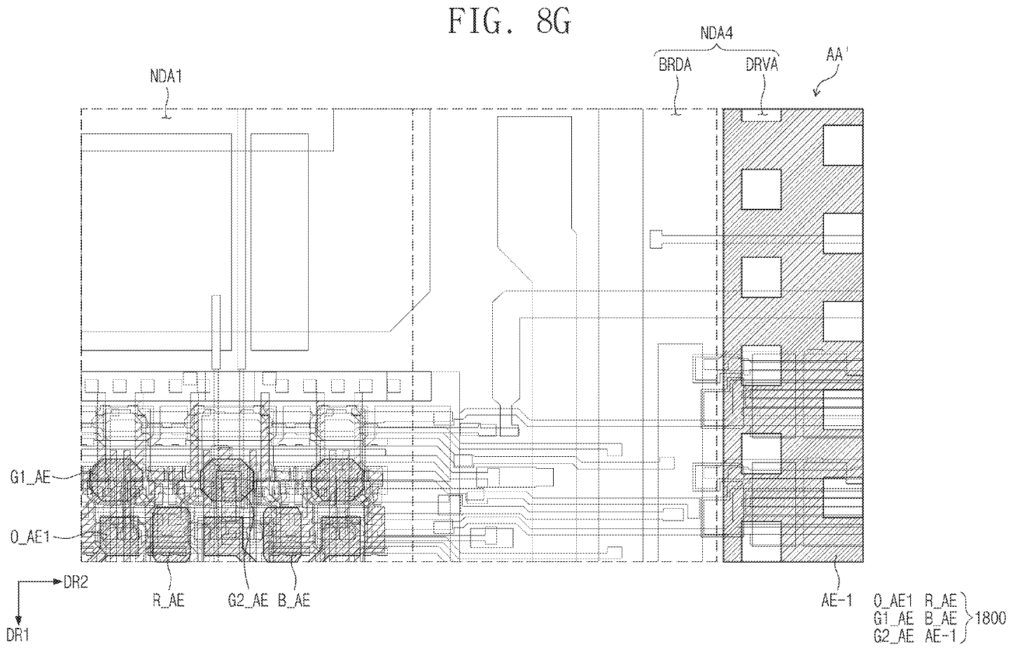

FIGS. 8A to 8G are views illustrating arrangements of conductive patterns included in a circuit layer according to an embodiment of the inventive concept. FIGS. 8A to 8G are plan views illustrating portions of an active area and a peripheral area of a circuit layer according to an embodiment. FIGS. 8A to 8G are enlarged views of the area AA′ of FIG. 7. That is, FIGS. 8A to 8G illustrate portions of the first peripheral area NDA1 and the fourth peripheral area NDA4.

Referring to FIGS. 8A to 8G, when viewed in a plane, each of the conductive patterns and semiconductor patterns is repeatedly arranged according to a predetermined rule. Plan views of portions of pixel driving circuits and a portion of sensor driving circuits are illustrated in FIGS. 8A to 8G.

A first circuit portion PDC1 and a second circuit portion PDC2 may have structures symmetrical to each other, the first circuit portion PDC1 may be a portion of the first green pixel driving circuit G1_PD illustrated in FIG. 4A, and the second circuit portion PDC2 may be a portion of the blue pixel driving circuit B_PD illustrated in FIG. 4A. A third circuit portion SDC may be a portion of the sensor driving circuit O_SD illustrated in FIG. 4A.

Although the first circuit portion PDC1 and the second circuit portion PDC2 having the structures symmetrical to each other are illustrated as an example in FIGS. 8A to 8G, a structure the same as that of the first circuit portion PDC1 may be continuously repeated, or a structure the same as that of the second circuit portion PDC2 may be continuously repeated. In addition, the first circuit portion PDC1, the third circuit portion SDC, and the second circuit portion PDC2 illustrated in FIGS. 8A to 8G may be sequentially arranged in the second direction DR2. However, embodiments of the inventive concept are not limited thereto.

In FIGS. 8A to 8G, the first circuit portion PDC1, the third circuit portion SDC, and the second circuit portion PDC2 may be disposed in the active area DA. The fourth peripheral area NDA4 (see FIG. 7) may include a first area BRDA and a second area DRVA. The first area BRDA may be a bridge area in which connection patterns for connecting the driving circuit and drivers are disposed. The second area DRVA may be a driving area in which the drivers are disposed. The second area DRVA is farther from the active area DA than the first area BRDA is.

Referring to FIGS. 6, 7, 8A, and 8B, a base conductive layer BML and a first semiconductor layer 1100 are illustrated. The base conductive layer BML may be disposed on the base layer BL. The base conductive layer BML may include the first driving voltage wiring ELV_W1. The first driving voltage wiring ELV_W1 may include a first portion BML_DL disposed in the active area DA and a second portion BML_ELV disposed in the peripheral area NDA. The first portion BML_DL may include a plurality of branches extending from the second portion BML_ELV toward the active area DA. The second portion BML_ELV may be disposed in the peripheral area NDA to surround the active area DA.

The first semiconductor layer 1100 may be disposed on the base conductive layer BML. The first semiconductor layer 1100 may be disposed between the base conductive layer BML and the first insulating layer 10. The first semiconductor layer 1100 may include a silicon semiconductor. For example, the silicon semiconductor may include amorphous silicon, polycrystalline silicon, and the like. For example, the first semiconductor layer 1100 may include low temperature polysilicon (LTPS).

The first semiconductor layer 1100 includes a first semiconductor pattern 1110 included in the first and second circuit portions PDC1 and PDC2, a second semiconductor pattern 1120 included in the third circuit portion SDC, and a third semiconductor pattern 1130 disposed in the second area DRVA.

Referring to FIGS. 6, 7, and 8A to 8C, a first conductive layer 1200 may be disposed on the first insulating layer 10. The first conductive layer 1200 may include, for example, a metal, an alloy, a conductive metal oxide, a transparent conductive material, or the like. For example, the first conductive layer 1200 may include silver (Ag), an alloy containing silver, molybdenum (Mo), an alloy containing molybdenum, aluminum (Al), an alloy containing aluminum, aluminum nitride (AlN), tungsten (W), tungsten nitride (WN), copper (Cu), indium tin oxide (ITO), indium zinc oxide (IZO), or the like, but is not particularly limited thereto.

The first conductive layer 1200 may include a first gate wiring 1210, a first gate electrode 1220, a second gate wiring 1230, a first sub-gate wiring 1250, and a second sub-gate wiring 1260.

The first gate wiring 1210 may extend in the second direction DR2. The first gate wiring 1210 corresponds to the j-th write scan line SWLj of FIG. 5A. For example, the j-th write scan signal SWj (see FIG. 5A) may be provided to the first gate wiring 1210.

The first gate wiring 1210, together with the first semiconductor pattern 1110, may constitute the second transistor T2 of FIG. 5A. In addition, the first gate wiring 1210, together with the first semiconductor pattern 1110, may constitute the fifth transistor T5 of FIG. 5A. The first gate wiring 1210, together with the second semiconductor pattern 1120, may constitute the output transistor ST3 of FIG. 5A.

The first gate electrode 1220 may be disposed in an island shape. The first gate electrode 1220, together with the first semiconductor pattern 1110, may constitute the first transistor T1 of FIG. 5A. The first gate electrode 1220 may correspond to the third electrode G1 of the first transistor T1 illustrated in FIG. 6.

The second gate wiring 1230 may extend in the second direction DR2. The second gate wiring 1230 may correspond to the j-th emission control line EMLj of FIG. 5A. For example, the j-th emission control signal EMj (see FIG. 5A) may be provided to the second gate wiring 1230. The second gate wiring 1230, together with the first semiconductor pattern 1110, may constitute the first and second emission control transistors ET1 and ET2 of FIG. 5A.

A second gate electrode 1240 may be disposed in an island shape. The second gate electrode 1240, together with the second semiconductor pattern 1120, may constitute the amplification transistor ST2 of FIG. 5A.

The first gate wiring 1210, the first gate electrode 1220, and the second gate wiring 1230 may be disposed in the active area DA.

The first sub-gate wiring 1250 may be disposed in the first area BRDA. The second sub-gate wiring 1260 may be disposed in the second area DRVA. The first sub-gate wiring 1250 and the second sub-gate wiring 1260 may be a component of a sub-pixel driving circuit for driving sub-pixels disposed in the second area DRVA.

Referring to FIGS. 6, 7, and 8A to 8D, the second insulating layer 20 may cover the first conductive layer 1200 and may be disposed on the first insulating layer 10. A second conductive layer 1300 may be disposed on the second insulating layer 20. The second conductive layer 1300 may include, for example, a metal, an alloy, a conductive metal oxide, a transparent conductive material, or the like.

The second conductive layer 1300 may include a third gate wiring 1310, a fourth gate wiring 1320, a capacitor electrode 1330, a first initialization voltage wiring 1340, and a first reset control wiring 1350.

The third gate wiring 1310 may extend in the second direction DR2. The third gate wiring 1310 may correspond to the j-th compensation scan line SCLj (see FIG. 5A). The fourth gate wiring 1320 may extend in the second direction DR2. The fourth gate wiring 1320 may correspond to the j-th initialization scan line SILj (see FIG. 5A). The capacitor electrode 1330 may overlap the first gate electrode 1220 and may be disposed in an island shape. For example, the capacitor electrode 1330, together with the first gate electrode 1220, may constitute the capacitor Cst (see FIG. The capacitor electrode 1330 may correspond to the upper electrode UE. The driving voltage ELVDD (see FIG. 5A) may be provided to the capacitor electrode 1330. In addition, an opening 1330_OP penetrating the capacitor electrode 1330 may be defined in the capacitor electrode 1330, and the first gate electrode 1220 may be partially exposed through the opening 1330_OP.

The first initialization voltage wiring 1340 may extend in the second direction DR2. The first initialization voltage wiring 1340 may correspond to the first initialization voltage line VL3 of FIG. 5A. The first initialization voltage VINT1 (see FIG. 5A) may be provided through the first initialization voltage wiring 1340. The first reset control wiring 1350 may extend in the second direction DR2. The first reset control wiring 1350 may correspond to the reset control line RCL of FIG. 5A. The reset control signal RST (see FIG. 5A) may be provided through the first reset control wiring 1350.

The second conductive layer 1300 may further include a third sub-gate wiring 1360 and a fourth sub-gate wiring 1370. The third sub-gate wiring 1360 and the fourth sub-gate wiring 1370 may be disposed in the first area BRDA and the second area DRVA.

The third sub-gate wiring 1360 and the fourth sub-gate wiring 1370 may be respectively connected to the first sub-gate wiring 1250 and the second sub-gate wiring 1260 to constitute the sub-pixel driving circuit of the sub-pixels.

The third insulating layer 30 may cover the second conductive layer 1300 and may be disposed on the second insulating layer 20. A second semiconductor layer including an oxide semiconductor may be disposed on the third insulating layer 30. The fourth insulating layer 40 may cover the second semiconductor layer and may be disposed on the third insulating layer 30. A third conductive layer may be disposed on the fourth insulating layer 40. The third conductive layer may include, for example, a metal, an alloy, a conductive metal oxide, a transparent conductive material, or the like. The third conductive layer may include a gate wiring and a second reset control wiring electrically connected to the first reset control wiring 1350.

Referring to FIGS. 6, 7, and 8A to 8E, the fifth insulating layer 50 may cover at least a portion of the third conductive layer and may be disposed on the fourth insulating layer 40. A fourth conductive layer 1600 may be disposed on the fifth insulating layer 50. The fourth conductive layer 1600 may include, for example, a metal, an alloy, a conductive metal oxide, a transparent conductive material, or the like. Hereinafter, only some of components included in the fourth conductive layer 1600 are illustrated in FIG. 8E for convenience of illustration.

The fourth conductive layer 1600 may include a first connection pattern 1610, a second connection pattern 1620, a third connection pattern 1630, a fourth connection pattern 1640, a fifth connection pattern 1650, a sixth connection pattern 1660, a first reset voltage wiring 1670, a second initialization voltage wiring 1680, seventh and eighth connection patterns 1691 and 1692, a first-first driving voltage wiring SD1_ELV, and a first-first reset voltage reinforcement wiring VRST_W1-1.

The first connection pattern 1610 may come in contact with the first semiconductor pattern 1110. A data signal (e.g., the i-th data signal Di (see FIG. 5A)) may be transmitted to the first semiconductor pattern 1110 through the first connection pattern 1610.

The second connection pattern 1620 may come in contact with the first semiconductor pattern 1110 and the capacitor electrode 1330 through contact portions respectively provided on one side and an opposite side of the second connection pattern 1620. The driving voltage ELVDD (see FIG. 5A) may be transmitted to the first semiconductor pattern 1110 through the second connection pattern 1620.

The third connection pattern 1630 may come in contact with the second semiconductor pattern and the first initialization voltage wiring 1340 through a contact portion. Accordingly, the first initialization voltage VINT1 may be transmitted to the fourth transistor T4 (see FIG. 5A) through the third connection pattern 1630.

The fourth connection pattern 1640 may come in contact with the first semiconductor pattern 1110 through a contact portion. The fourth connection pattern 1640 may transmit the driving current Id (see FIG. 5A) from the first semiconductor pattern 1110 to a corresponding light emitting element (e.g., the red light emitting element ED_R (see FIG. 5A)).

The fifth connection pattern 1650 may come in contact with the first semiconductor pattern 1110 through a contact portion. The fifth connection pattern 1650 may electrically connect the first transistor T1 and the third transistor T3 (see FIG. 5A).

The sixth connection pattern 1660 may come in contact with the first semiconductor pattern 1110 through a contact portion. The sixth connection pattern 1660 may electrically connect the second emission control transistor ET2 (see FIG. and the third transistor T3.

The first reset voltage wiring 1670 may extend in the second direction DR2. The first reset voltage wiring 1670 may correspond to the reset voltage line VL5 of FIG. 5A. The reset voltage Vrst (see FIG. 5A) may be provided to the first reset voltage wiring 1670. The first reset voltage wiring 1670 may be connected to the reset transistor ST1 (see FIG. 5A) through a contact portion. The reset transistor ST1 may receive the reset voltage Vrst through the first reset voltage wiring 1670. However, unlike the illustration in FIG. 8E, the first reset voltage wiring 1670 may also be connected to the fourth gate wiring 1320 through the contact portion. In this case, the reset transistor ST1 may receive the j-th initialization scan signal SIj as the reset voltage Vrst through the first reset voltage wiring 1670.

The second initialization voltage wiring 1680 may extend in the second direction DR2. The second initialization voltage wiring 1680 may correspond to the second initialization voltage line VL4 of FIG. 5A. The second initialization voltage VINT2 (see FIG. 5A) may be provided through the second initialization voltage wiring 1680. The second initialization voltage wiring 1680 may extend to the first area BRDA. Thereafter, the second initialization voltage wiring 1680 may be connected to the second initialization voltage reinforcement wiring AINT_W of a fifth conductive layer through a contact hole in the first area BRDA.

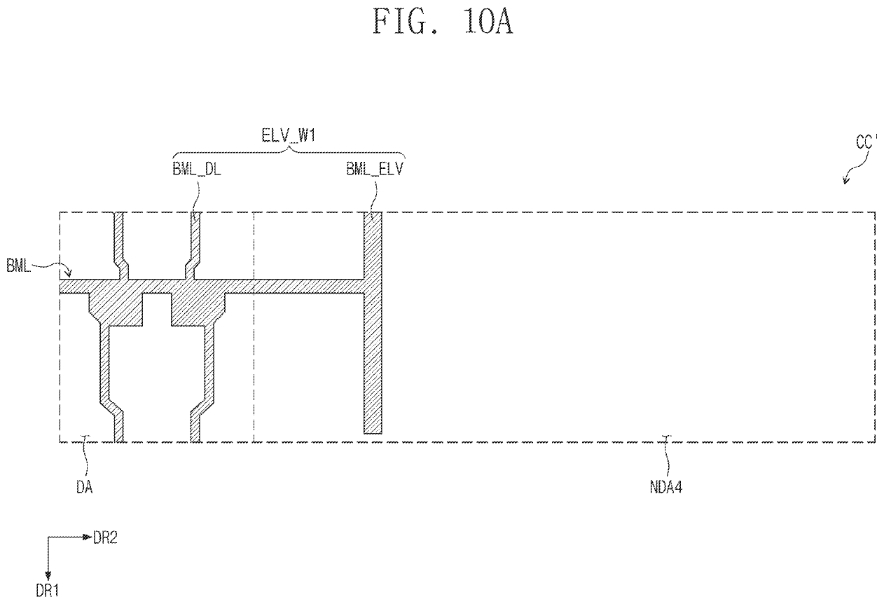

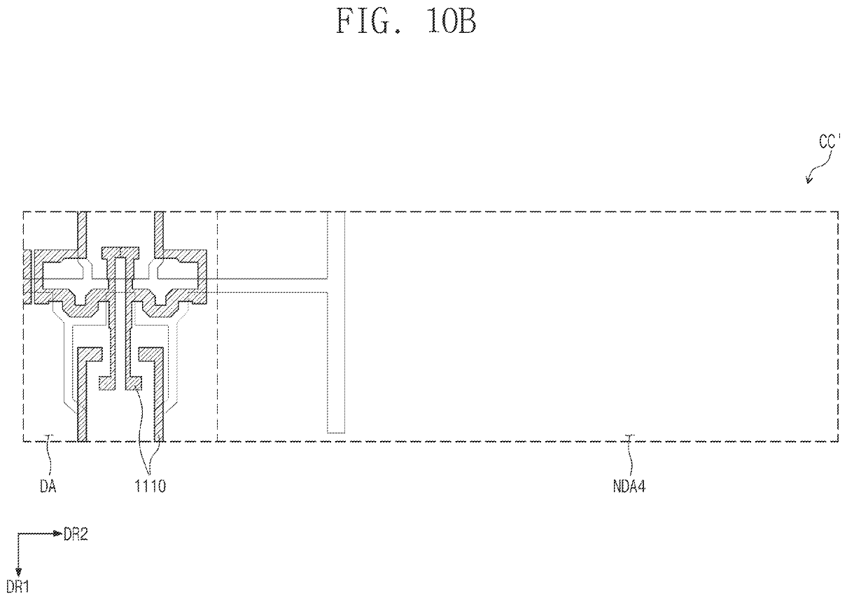

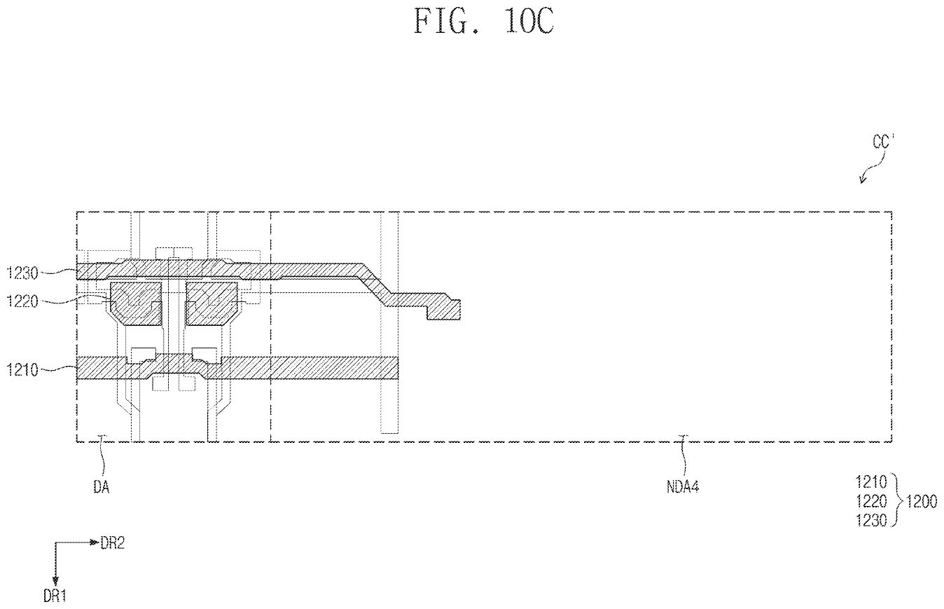

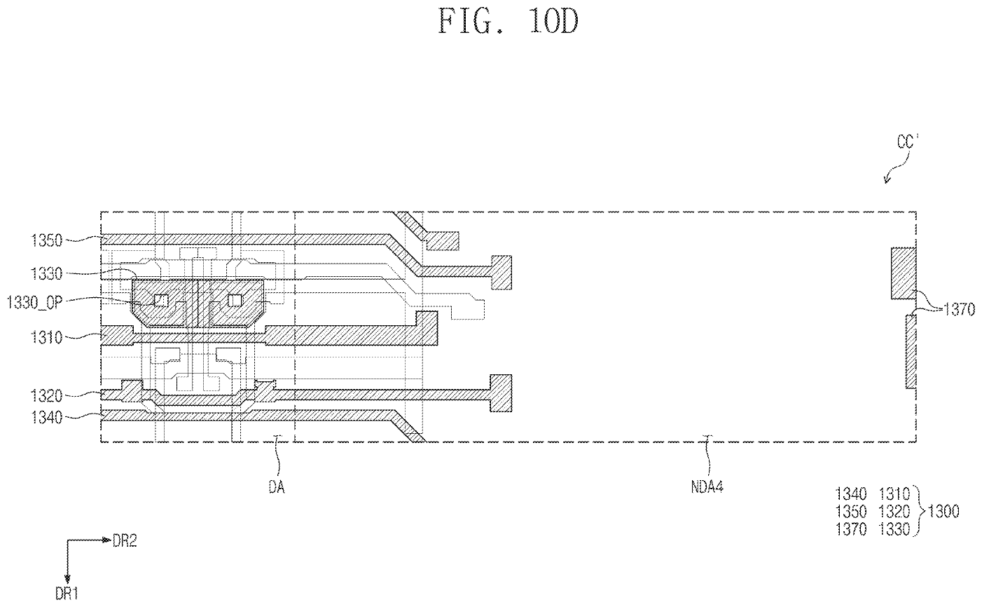

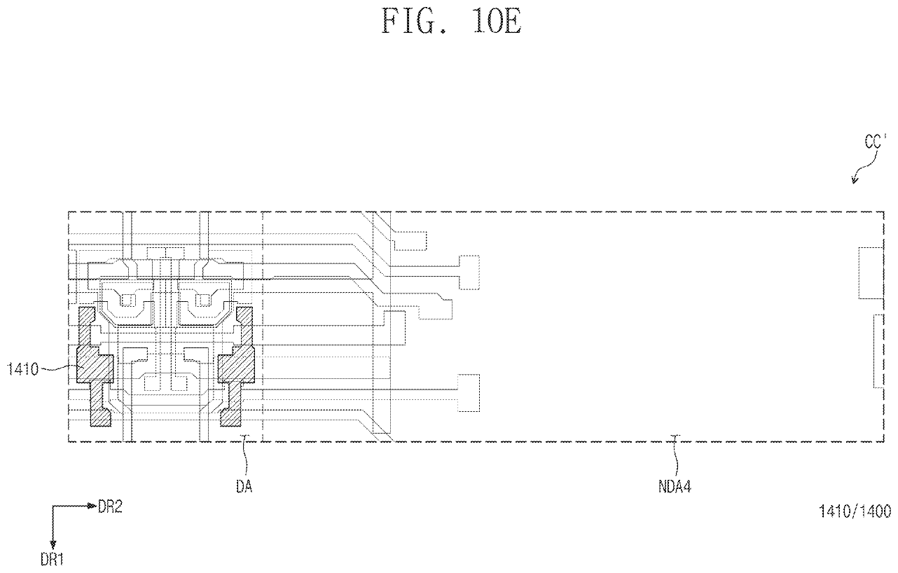

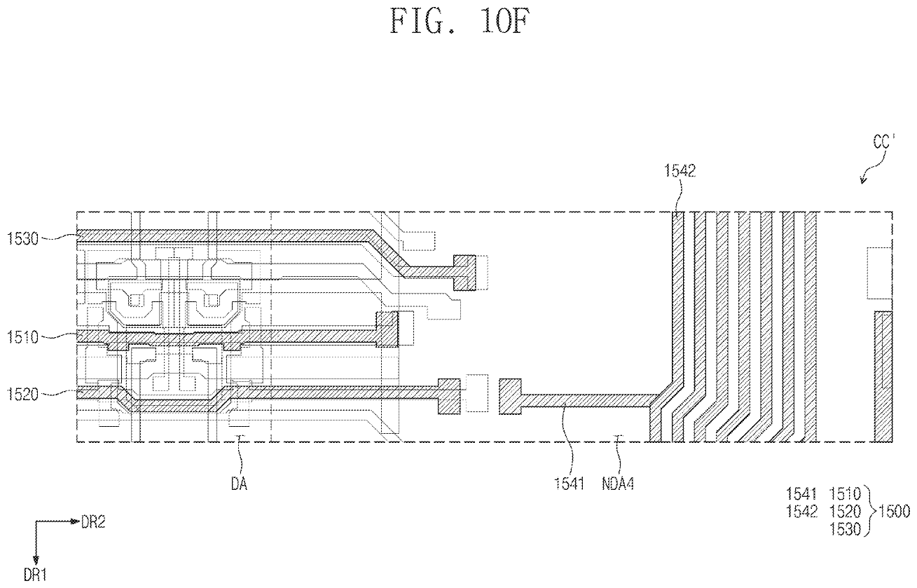

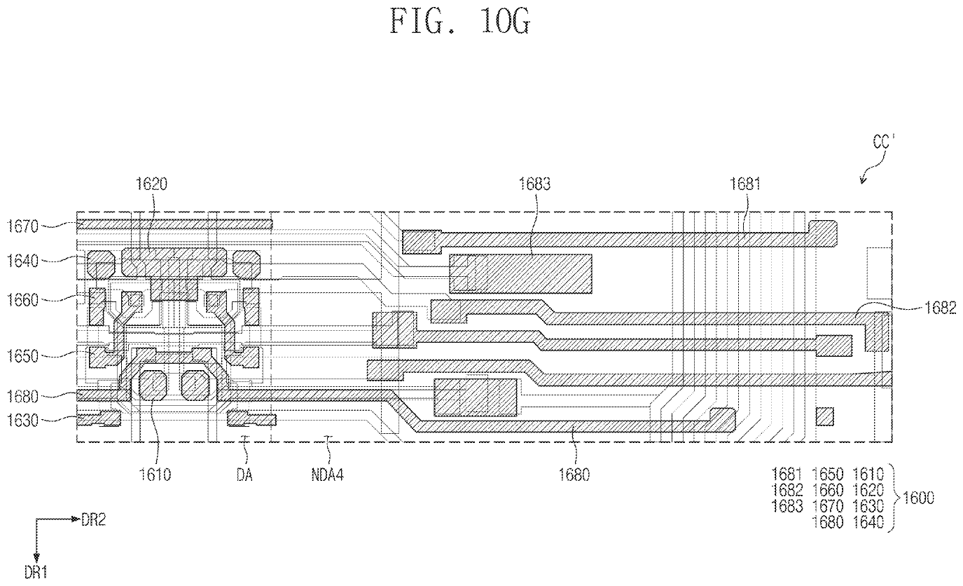

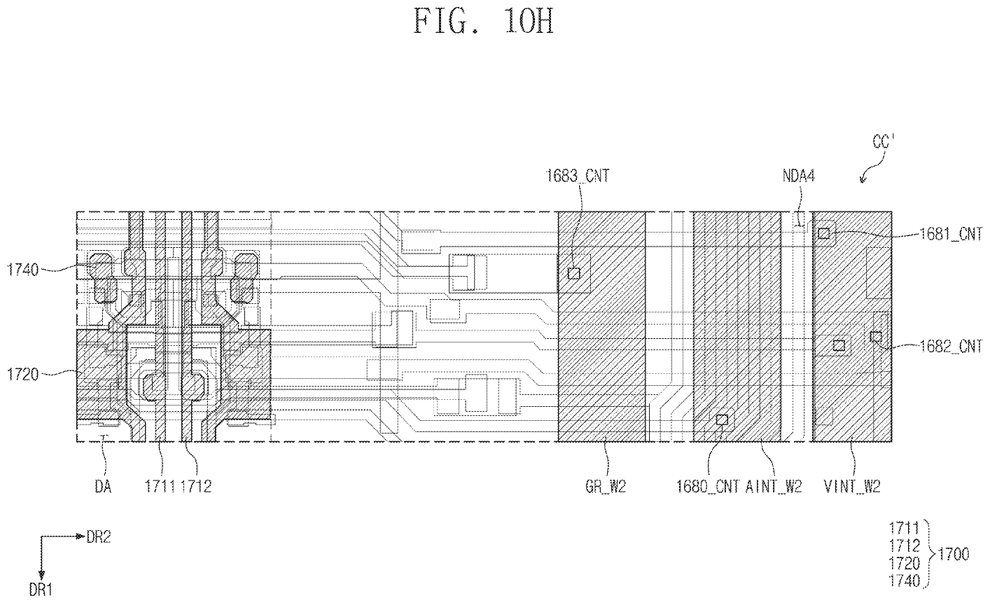

One side of the seventh connection pattern 1691 may come in contact with the second semiconductor pattern 1120 through a contact portion. An opposite side of the seventh connection pattern 1691 may come in contact with a sixth gate wiring 1520 (see FIG. 10F) through the contact portion. The output transistor ST3 may receive the j-th compensation scan signal SCj through the seventh connection pattern 1691.

One side of the eighth connection pattern 1692 may come in contact with a fourth semiconductor pattern through a contact portion. An opposite other side of the eighth connection pattern 1692 may come in contact with the second gate electrode 1240 through a contact portion. The eighth connection pattern 1692 may electrically connect the reset transistor ST1 to the amplification transistor ST2 (see FIG. 5A).

The first-first driving voltage wiring SD1_ELV may be connected to the first driving voltage wiring ELV_W1 through contact holes ELV_CNT1. The first-first driving voltage wiring SD1_ELV may have a bar shape extending in the second direction DR2.

The fourth conductive layer 1600 may further include a first bridge pattern 1681, a second bridge pattern 1682, a third bridge pattern 1683, and a fourth bridge pattern 1693 disposed in the first area BRDA.

The first bridge pattern 1681 and the second bridge pattern 1682 may be respectively connected to the first initialization voltage wiring 1340 and the second gate wiring 1230. The third bridge pattern 1683 may have an island shape. The third bridge pattern 1683 may be connected to the first reset control wiring 1350. The fourth bridge pattern 1693 may be connected to the first gate wiring 1210.

The fourth conductive layer 1600 may further include sub-connection patterns 1694 and 1695 disposed in the second area DRVA. The sub-connection patterns 1694 and 1695 may be connected to the fourth sub-gate wiring 1370.

The first reset voltage reinforcement wiring VRST_W1 may include the first-first reset voltage reinforcement wiring VRST_W1-1 of the fourth conductive layer 1600 and a first-second reset voltage reinforcement wiring VRST_W1-2 (see FIG. 8F) of a fifth conductive layer 1700 (see FIG. 8F). The first-first reset voltage reinforcement wiring VRST_W1-1 may be disposed above the first-first driving voltage wiring SD1_ELV in the first direction DR1. The first-first reset voltage reinforcement wiring VRST_W1-1 may have a shape of a wide metal wiring extending in the second direction DR2. The first-first reset voltage reinforcement wiring VRST_W1-1 may thereafter be connected to the first-first reset voltage reinforcement wiring VRST_W1-2 of the fifth conductive layer 1700 to reduce resistance.

Referring to FIGS. 6, 7, and 8A to 8F, the sixth insulating layer 60 may cover at least a portion of the fourth conductive layer 1600 and may be disposed on the fifth insulating layer 50. The fifth conductive layer 1700 may be disposed on the sixth insulating layer 60. The fifth conductive layer 1700 may include, for example, a metal, an alloy, a conductive metal oxide, a transparent conductive material, or the like.

The fifth conductive layer 1700 may include a first data wiring 1711, a second data wiring 1712, a driving voltage wiring 1720, a ninth connection pattern 1730, a tenth connection pattern 1740, an eleventh connection pattern 1750, a readout wiring 1760, a first-second driving voltage wiring SD2_ELV, and the first-second reset voltage reinforcement wiring VRST_W1-2.

The first and second data wirings 1711 and 1712 may extend in the first direction DR1. The first and second data wirings 1711 and 1712 may be spaced apart from each other in the second direction DR2. One of the first and second data wirings 1711 and 1712 may correspond to the i-th data line DLi of FIG. 5A. For example, the i-th data signal Di may be provided to one of the first and second data wirings 1711 and 1712. Each of the first and second data wirings 1711 and 1712 may come in contact with the first connection pattern 1610 through a contact portion.

The driving voltage wiring 1720 may extend in the first direction DR1 and may overlap the first circuit portion PDC1 and the second circuit portion PDC2. The driving voltage wiring 1720 may correspond to the first driving voltage line VL1 of FIG. 5A. For example, the first driving voltage ELVDD may be provided to the driving voltage wiring 1720. The driving voltage wiring 1720 may come in contact with the second connection pattern 1620 through a contact portion.

The ninth connection pattern 1730 may be disposed in an island shape. The ninth connection pattern 1730 may come in contact with the fourth semiconductor pattern through a contact portion provided on one side of the ninth connection pattern 1730. The ninth connection pattern 1730 may be electrically connected to the first sensing anode electrode O_AE1 (see FIG. 4A) of the first light receiving element OPD1 of FIG. 5A through a contact portion provided on an opposite side of the ninth connection pattern 1730.

The tenth connection pattern 1740 may be disposed in an island shape. The tenth connection pattern 1740 may come in contact with the first semiconductor pattern 1110 through a contact portion provided on one side of the tenth connection pattern 1740. The tenth connection pattern 1740 may be electrically connected to an anode electrode (e.g., the red anode electrode R_AE (see FIG. 4A)) of a corresponding light emitting element (e.g., the red light emitting element ED_R (see FIG. 4A)) through a contact portion provided on an opposite side of the tenth connection pattern 1740.

The eleventh connection pattern 1750 includes a contact portion 1750_CNT protruding on one side thereof and has a bar shape extending in the first direction DR1. The eleventh connection pattern 1750 may come in contact with the first reset voltage wiring 1670 through the contact portion 1750_CNT provided on the one side. The eleventh connection pattern 1750 may extend in the first direction DR1 and may be connected to the first-second reset voltage reinforcement wiring VRST_W1-2 disposed at an upper side thereof. Accordingly, the eleventh connection pattern 1750 may electrically connect the first-second reset voltage reinforcement wiring VRST_W1-2 and the first reset voltage wiring 1670.

The readout wiring 1760 may extend in the first direction DR1. The readout wiring 1760 may be disposed between two data wirings (e.g., the first and second data wirings 1711 and 1712) disposed adjacent to each other. The readout wiring 1760 may correspond to the d-th readout line RLd of FIG. 5A. For example, the d-th readout signal FSd may be transmitted to the readout wiring 1760. The readout wiring 1760 may come in contact with the output transistor ST3 (see FIG. 5A) through a contact portion.

The first-second driving voltage wiring SD2_ELV may be connected to the first-first driving voltage wiring SD1_ELV through contact holes ELV_CNT2. The first-second driving voltage wiring SD2_ELV may include a plurality of parts separated from each other. The first driving voltage wiring ELV_W1, the (1-1)-th driving voltage wiring SD1_ELV, and the first-second driving voltage wiring SD2_ELV may be electrically connected to each other through the contact holes ELV_CNT1 and ELV_CNT2.

The first-second reset voltage reinforcement wiring VRST_W1-2 may be disposed above the first-second driving voltage wiring SD2_ELV in the first direction DR1. The first-second reset voltage reinforcement wiring VRST_W1-2 may be a bar-shaped wide metal wiring extending in the second direction DR2. The first-second reset voltage reinforcement wiring VRST_W1-2 may be connected to the first-first reset voltage reinforcement wiring VRST_W1-1 (see FIG. 8E) through contact portions VRST_CNT. Accordingly, the first-second reset voltage reinforcement wiring VRST_W1-2 may be electrically connected to the first reset voltage wiring 1670 of the active area DA through the first-first reset voltage reinforcement wiring VRST_W1-1 connected to the eleventh connection pattern 1750.

The first-second reset voltage reinforcement wiring VRST_W1-2 may include two or more parts spaced apart from each other. For example, the first-second reset voltage reinforcement wiring VRST_W1-2 may include first and second parts spaced apart from each other, and the readout wiring 1760 may pass between the first and second parts.

The fifth conductive layer 1700 may include the second reset control reinforcement wiring GR_W2, the first-second initialization voltage reinforcement wiring VINT_W2, and the second-second initialization voltage reinforcement wiring AINT_W2 in the fourth peripheral area NDA4. Each of the second reset control reinforcement wiring GR_W2, the first-second initialization voltage reinforcement wiring VINT_W2, and the second-second initialization voltage reinforcement wiring AINT_W2 may have a bar shape extending in the first direction DR1. The second reset control reinforcement wiring GR_W2, the first-second initialization voltage reinforcement wiring VINT_W2, and the second-second initialization voltage reinforcement wiring AINT_W2 may be disposed in the first area BRDA disposed between the active area DA and the second area DRVA.

The second reset control reinforcement wiring GR_W2 may be connected to the third bridge pattern 1683 through a contact portion 1683_CNT. The second reset control reinforcement wiring GR_W2 may be electrically connected to the first reset control wiring 1350 through the third bridge pattern 1683.

The first-second initialization voltage reinforcement wiring VINT_W2 may be connected to the first bridge pattern 1681 and the second bridge pattern 1682 through contact portions 1681_CNT and 1682_CNT, respectively. The first-second initialization voltage reinforcement wiring VINT_W2 may be electrically connected to the first initialization voltage wiring 1340 through the first bridge pattern 1681 and the second bridge pattern 1682.

The second-second initialization voltage reinforcement wiring AINT_W2 may be disposed between the second reset control reinforcement wiring GR_W2 and the first-second initialization voltage reinforcement wiring VINT_W2. The second-second initialization voltage reinforcement wiring AINT_W2 may be electrically connected to the second initialization voltage wiring 1680. The second initialization voltage wiring 1680 may be provided in plurality. The second-second initialization voltage reinforcement wiring AINT_W2 may be directly connected to the plurality of second initialization voltage wirings 1680 through a contact portion 1680_CNT.

Referring to FIGS. 6, 7, and 8A to 8G, the eighth insulating layer 80 may cover at least a portion of the fifth conductive layer 1700 and may be disposed on the sixth insulating layer 60. A sixth conductive layer 1800 may be disposed on the eighth insulating layer 80. The seventh insulating layer 70 may be disposed between the sixth insulating layer 60 and the eighth insulating layer 80.

The sixth conductive layer 1800 may include the plurality of anode electrodes. Referring to FIGS. 4A and 4B, the sixth conductive layer 1800 may include the first and second sensing anode electrodes O_AE1 and O_AE2, the first green anode electrode G1_AE, the second green anode electrode G2_AE, the red anode electrode R_AE, and the blue anode electrode B_AE.

The sixth conductive layer 1800 may further include a sub-anode electrode AE-1 disposed in the second area DRVA. The sub-anode electrode AE-1 may constitute one of the sub-pixels disposed in the second area DRVA.

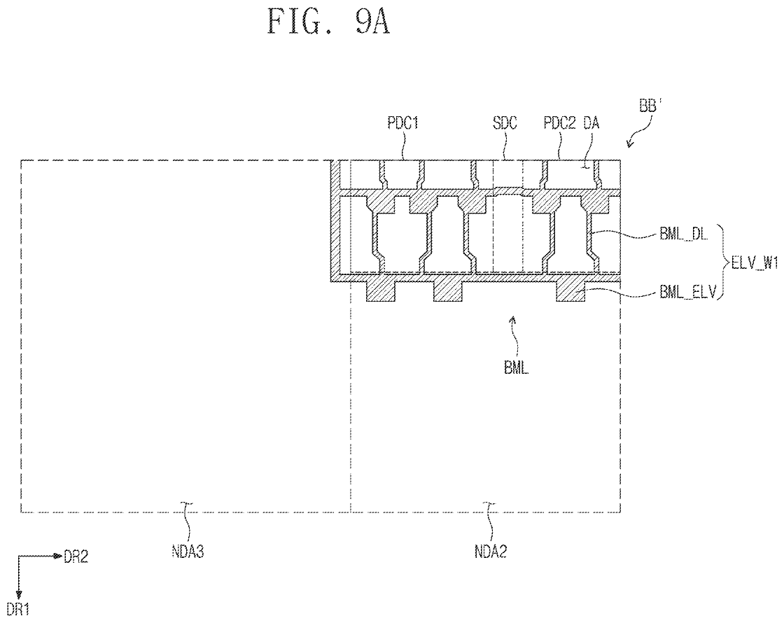

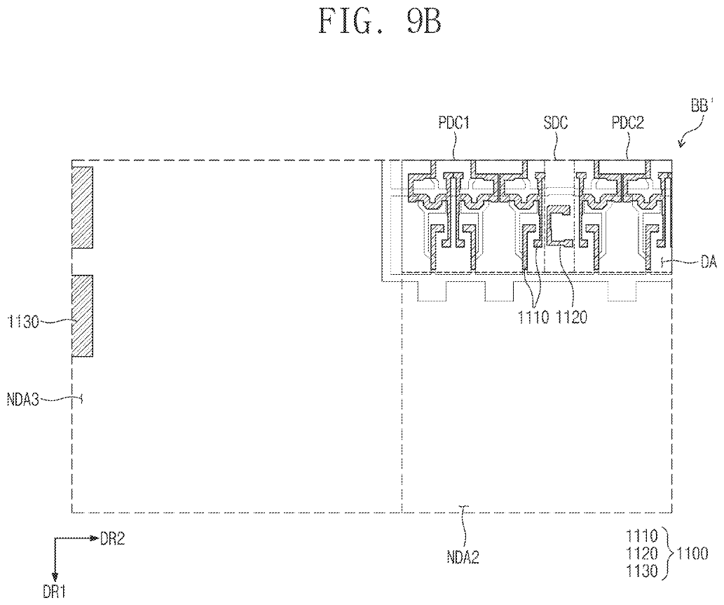

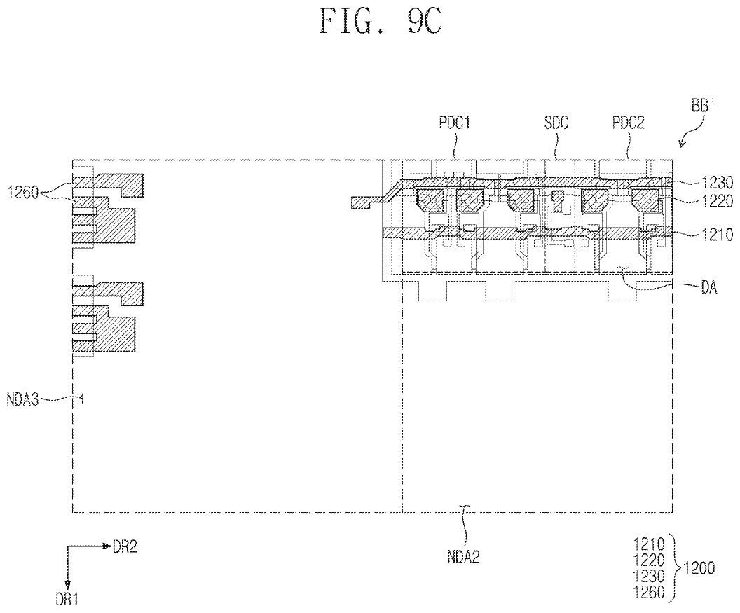

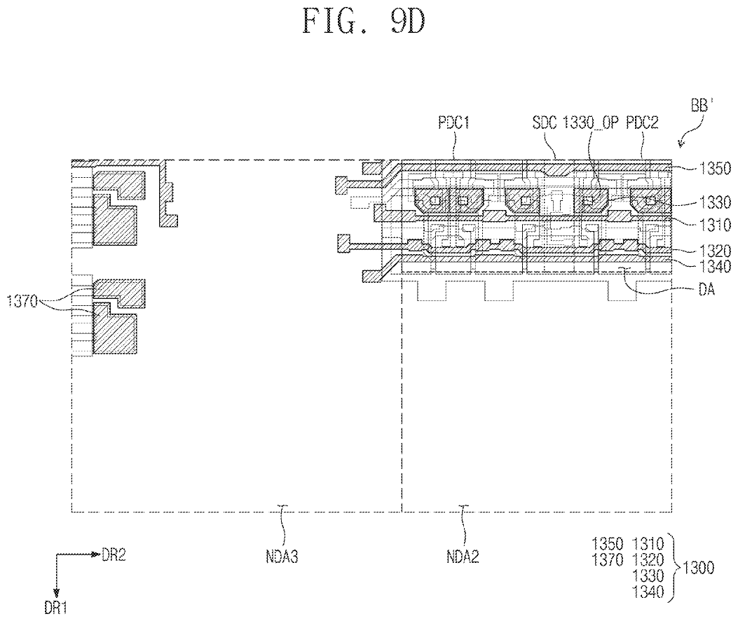

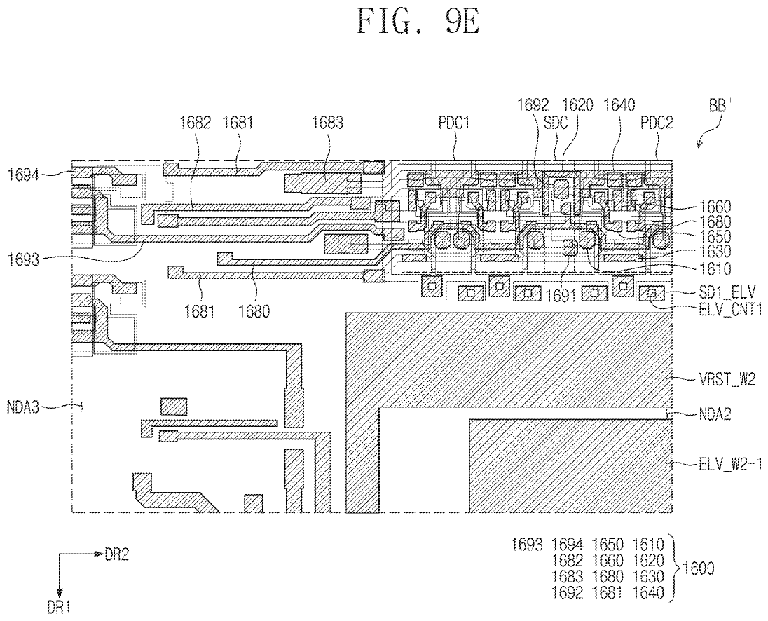

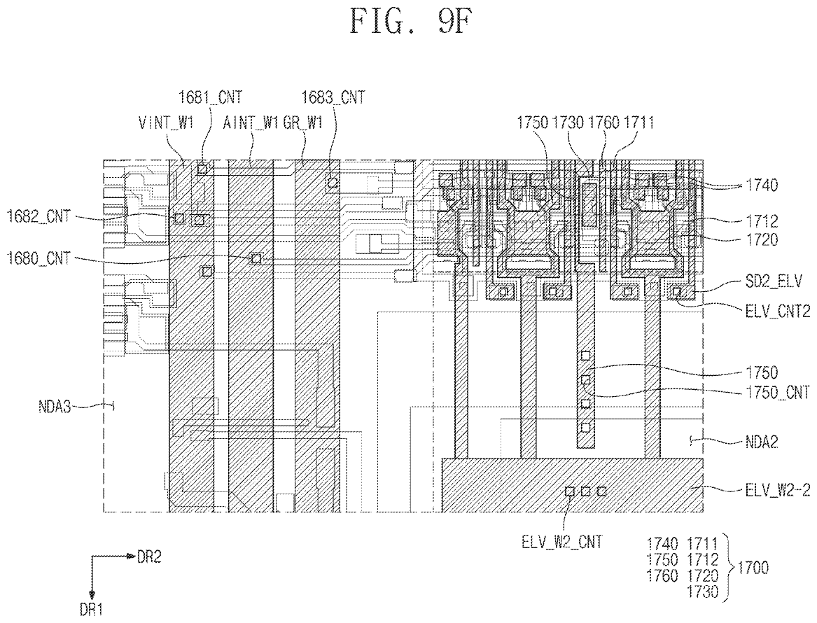

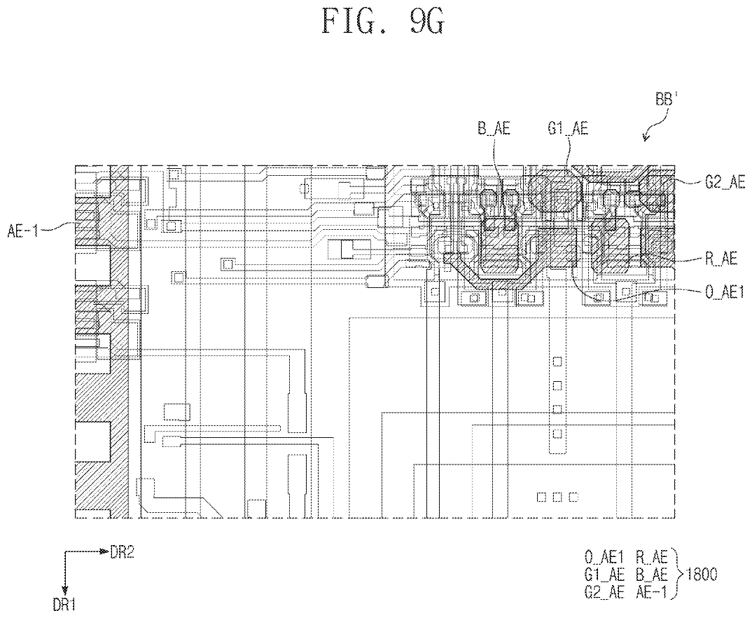

FIGS. 9A to 9G are views illustrating arrangements of conductive patterns included in a circuit layer according to an embodiment of the inventive concept. FIGS. 9A to 9G are enlarged views of the area BB′ of FIG. 7. That is, FIGS. 9A to 9G illustrate portions of the second peripheral area NDA2 and the third peripheral area NDA3.

Referring to FIGS. 9A to 9G, when viewed in a plane, each of the conductive patterns and semiconductor patterns may have a structure in which each of the conductive patterns and the semiconductor patterns is repeated and arranged according to a predetermined rule. Plan views of portions of pixel driving circuits and a portion of a sensor driving circuit are illustrated in FIGS. 9A to 9G. A first circuit portion PDC1 and a second circuit portion PDC2 may have structures symmetrical to each other, the first circuit portion PDC1 may be a portion of the first green pixel driving circuit G1_PD illustrated in FIG. 4A, and the second circuit portion PDC2 may be a portion of the blue pixel driving circuit B_PD illustrated in FIG. 4A. A third circuit portion SDC may be a portion of the sensor driving circuit O_SD illustrated in FIG. 4A.

The structure of the active area DA in FIGS. 9A to 9G may be substantially the same as in FIGS. 8A to 8G. A difference between FIGS. 8A to 8G and FIGS. 9A to 9G may occur in the second and third peripheral areas NDA2 and NDA3. For convenience of explanation, most of descriptions to be given with reference to the active area DA with reference to FIGS. 9A to 9G will be omitted by referring to the descriptions given with reference the active area DA with reference to FIGS. 8A to 8G. That is, for convenience of explanation, the descriptions to be given with reference to FIGS. 9A to 9G will be omitted when overlapping with the descriptions given with reference to FIGS. 8A to 8G.

In FIGS. 6, 7, and 9E, the fourth conductive layer 1600 may include the second reset voltage reinforcement wiring VRST_W2 and a second-first driving voltage wiring ELV_W2-1.

The second reset voltage reinforcement wiring VRST_W2 may be disposed below the first-first driving voltage wiring SD1_ELV so as to be close to the first-first driving voltage wiring SD1_ELV. The second reset voltage reinforcement wiring VRST_W2 may include a bar-shaped wide metal wiring extending in the second direction DR2.

The second-first driving voltage wiring ELV_W2-1 may be disposed below the second reset voltage reinforcement wiring VRST_W2 in the first direction DR1. The second-first driving voltage wiring ELV_W2-1 may include a wide metal wiring.

In FIGS. 6, 7, 9E, and 9F, according to embodiments, the second reset voltage reinforcement wiring VRST_W2 is not disposed in the fifth conductive layer 1700. The second reset voltage reinforcement wiring VRST_W2 may be connected to the eleventh connection pattern 1750 through the contact portion 1750_CNT. That is, the second reset voltage reinforcement wiring VRST_W2 may come in direct contact with the first reset voltage wiring 1670 through the eleventh connection pattern 1750.

A second-second driving voltage wiring ELV_W2-2 may be disposed in the fifth conductive layer 1700. The second-second driving voltage wiring ELV_W2-2 may be connected to the driving voltage wiring 1720. The second-second driving voltage wiring ELV_W2-2 may be connected to the second-first driving voltage wiring ELV_W2-1 through a contact portion ELV_W2_CNT. The second-first driving voltage wiring ELV_W2-1 and the second-second driving voltage wiring ELV_W2-2 may be included in the second driving voltage wiring ELV_W2.

Referring to FIGS. 9E to 9F, in the second peripheral area NDA2, the second reset voltage reinforcement wiring VRST_W2 may be disposed in the fourth conductive layer 1600. The second driving voltage wiring ELV_W2 may be disposed in the fourth conductive layer 1600 and the fifth conductive layer 1700. The fifth conductive layer 1700 may include the first reset control reinforcement wiring GR_W1, the first-first initialization voltage reinforcement wiring VINT_W1, and the second-first initialization voltage reinforcement wiring AINT_W1 in the third peripheral area NDA3.

FIGS. 10A to 10I are views illustrating arrangements of conductive patterns included in a circuit layer according to an embodiment of the inventive concept. FIGS. 10A to 10I are enlarged views of the area CC′ of FIG. 7. That is, FIGS. to 10I illustrate a portion of the fourth peripheral area NDA4. The configuration of the circuit layer DP_CL of the active area DA in FIGS. 10A to 10I is substantially the same as in FIGS. 8A to 8G. Thus, for convenience of explanation, descriptions to be given with reference to FIGS. 10A to 10I will be omitted when overlapping with the descriptions given with reference to FIGS. 8A to 8G.

Referring to FIGS. 6, 7, 10D, and 10E, the third insulating layer 30 may cover the second conductive layer 1300 and may be disposed on the second insulating layer 20. A second semiconductor layer 1400 may be disposed on the third insulating layer 30. The second semiconductor layer 1400 may include an oxide semiconductor. The second semiconductor layer 1400 may be disposed in a layer different from a layer in which the first semiconductor layer 1100 is disposed, and according to embodiments, does not overlap the first semiconductor layer 1100. The second semiconductor layer 1400 includes a third semiconductor pattern 1410.

Referring to FIGS. 6, 7, and 10D to 10F, the fourth insulating layer 40 may cover the second semiconductor layer 1400 and may be disposed on the third insulating layer 30. A third conductive layer 1500 may be disposed on the fourth insulating layer 40. The third conductive layer 1500 may include, for example, a metal, an alloy, a conductive metal oxide, a transparent conductive material, or the like.

The third conductive layer 1500 may include a fifth gate wiring 1510, the sixth gate wiring 1520, and a second reset control wiring 1530.

The fifth gate wiring 1510 may extend in the second direction DR2. The fifth gate wiring 1510 may overlap the third gate wiring 1310 and the third semiconductor pattern 1410. In an embodiment, the fifth gate wiring 1510 may come in contact with the third gate wiring 1310 through a contact portion. Accordingly, the j-th compensation scan signal SCj applied to the third gate wiring 1310 may be provided to the fifth gate wiring 1510. The third gate wiring 1310, the third semiconductor pattern 1410, and the fifth gate wiring 1510 may constitute the third transistor T3 of FIG. 5A.

The sixth gate wiring 1520 may extend in the second direction DR2. The sixth gate wiring 1520 may overlap the fourth gate wiring 1320 and the third semiconductor pattern 1410. The sixth gate wiring 1520 may be electrically connected to the fourth gate wiring 1320. The j-th initialization scan signal SIj may be provided to the sixth gate wiring 1520. The fourth gate wiring 1320, the sixth gate wiring 1520, and the third semiconductor pattern 1410 may constitute the fourth transistor T4 of FIG. 5A.

The second reset control wiring 1530 may extend in the second direction DR2. The second reset control wiring 1530 is electrically insulated from the fifth gate wiring 1510. The second reset control wiring 1530 is spaced apart from the fifth gate wiring 1510 in the first direction DR1. The second reset control wiring 1530 is electrically insulated from the sixth gate wiring 1520. The second reset control wiring 1530 is spaced apart from the sixth gate wiring 1520 in the first direction DR1. The second reset control wiring 1530 may correspond to the reset control line RCL of FIG. 5A. The reset control signal RST (see FIG. 5A) may be provided through the second reset control wiring 1530.

The third conductive layer 1500 may further include seventh gate wirings 1541 and 1542. The seventh gate wirings 1541 and 1542 may include a plurality of wirings. The seventh gate wirings 1542 may be disposed in the fourth peripheral area NDA4 and may include a plurality of wirings extending in the first direction DR1.

Referring to FIGS. 6, 7, and 10H, the fifth conductive layer 1700 may include the second reset control reinforcement wiring GR_W2, the first-second initialization voltage reinforcement wiring VINT_W2, and the second-second initialization voltage reinforcement wiring AINT_W2 in the fourth peripheral area NDA4.

Each of the second reset control reinforcement wiring GR_W2, the first-second initialization voltage reinforcement wiring VINT_W2, and the second-second initialization voltage reinforcement wiring AINT_W2 may be provided as a wide metal wiring extending in the first direction DR1. The second reset control reinforcement wiring GR_W2, the first-second initialization voltage reinforcement wiring VINT_W2, and the second-second initialization voltage reinforcement wiring AINT_W2 may transmit a signal to a corresponding portion of the fourth conductive layer 1600 disposed in the active area DA by coming in contact with, through contact portions, a plurality of bridge patterns that are disposed in the fourth conductive layer 1600 and each extend in the second direction DR2. FIGS. 8E to 8F provide further detailed descriptions of the second reset control reinforcement wiring GR_W2, the first-second initialization voltage reinforcement wiring VINT_W2, and the second-second initialization voltage reinforcement wiring AINT_W2.

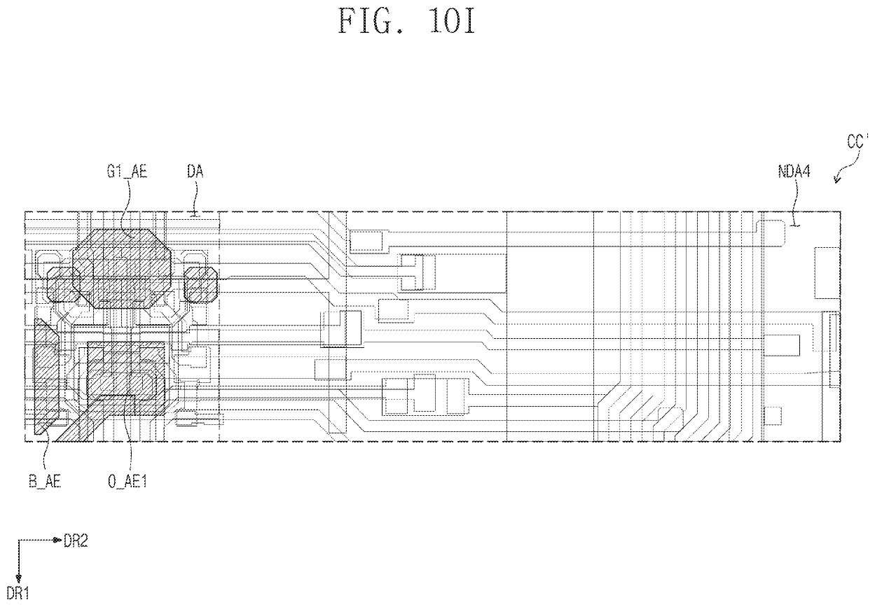

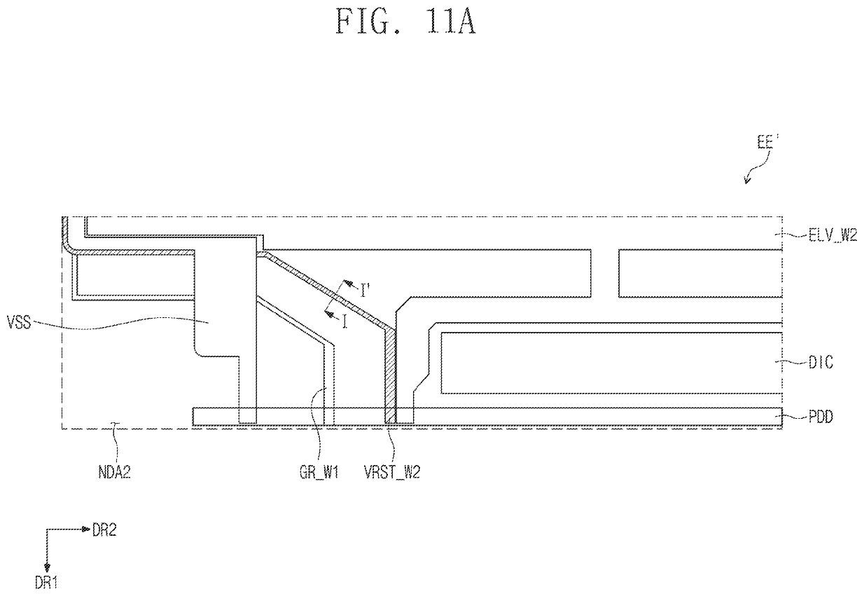

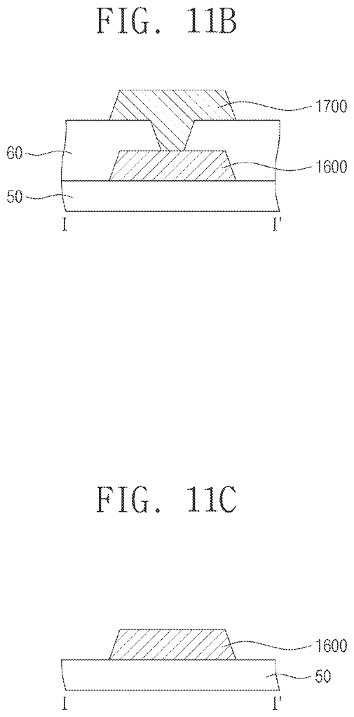

FIG. 11A is an enlarged view of a portion of a circuit layer according to an embodiment of the inventive concept. FIGS. 11B and 11C are cross-sectional views taken along line I-f of FIG. 11A according to an embodiment of the inventive concept.

FIG. 11A is an enlarged view of the area EE of FIG. 7. FIG. 11A illustrates a portion of the second peripheral area NDA2 of FIG. 7. FIG. 11A illustrates wirings at a lead-in end of the display panel DP.

In FIG. 11A, the second driving voltage wiring ELV_W2, the third driving voltage wiring VSS, the second reset voltage reinforcement wiring VRST_W2, and the first reset control reinforcement wiring GR_W1 may be connected to a pad part PDD. In an embodiment, the second driving voltage wiring ELV_W2, the third driving voltage wiring VSS, the second reset voltage reinforcement wiring VRST_W2, and the first reset control reinforcement wiring GR_W1 may be connected to a flexible circuit board and a main driving circuit through the pad part PDD.

Connection wirings for connecting the second driving voltage wiring ELV_W2, the third driving voltage wiring VSS, the second reset voltage reinforcement wiring VRST_W2, and the first reset control reinforcement wiring GR_W1 to the pad part PDD may be implemented with wide metal wirings.

In FIGS. 11B and 11C, each of the second driving voltage wiring ELV_W2, the third driving voltage wiring VSS, the second reset voltage reinforcement wiring VRST_W2, and the first reset control reinforcement wiring GR_W1 may be implemented as a double wiring or a single wiring. Referring to FIG. 11B, in the area EE′ where the lead-in end of the display panel is disposed, each of the second driving voltage wiring ELV_W2, the third driving voltage wiring VSS, the second reset voltage reinforcement wiring VRST_W2, and the first reset control reinforcement wiring GR_W1 may include, unlike the case in the active area DA, a double wiring or a single wiring. For example, the second reset voltage reinforcement wiring VRST_W2 is disposed only in the fourth conductive layer 1600 in the active area DA, whereas, in FIG. 11B, the second reset voltage reinforcement wiring VRST_W2 is disposed in the fourth and fifth conductive layers 1600 and 1700 in the lead-in end connected to the pad part, and thus, may be implemented as the double wiring. The double wiring of the second reset voltage reinforcement wiring VRST_W2 may come in contact with each other through a contact portion CNT. In FIG. 11C, the second reset voltage reinforcement wiring VRST_W2 may be implemented as the single wiring disposed only in the fourth conductive layer 1600 also at the lead-in end as in the active area DA.

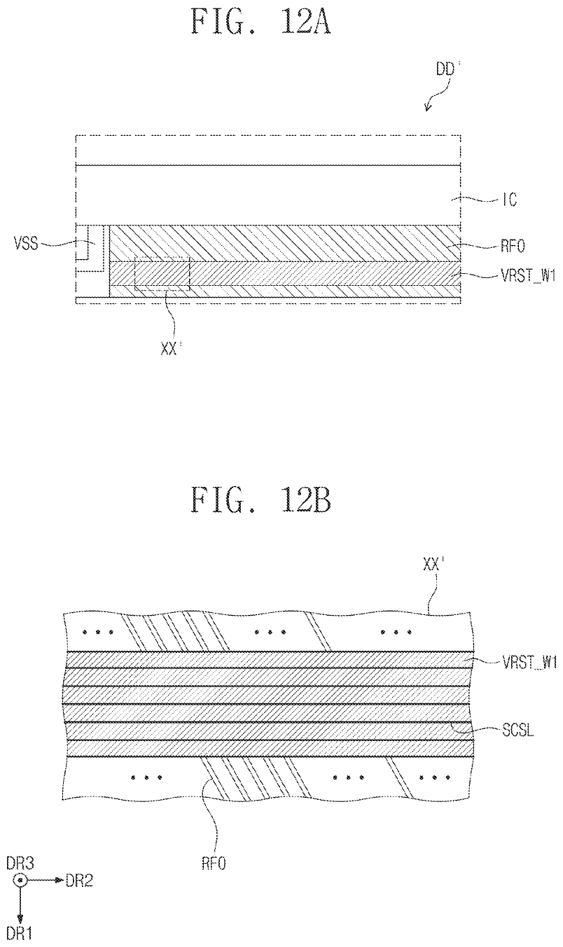

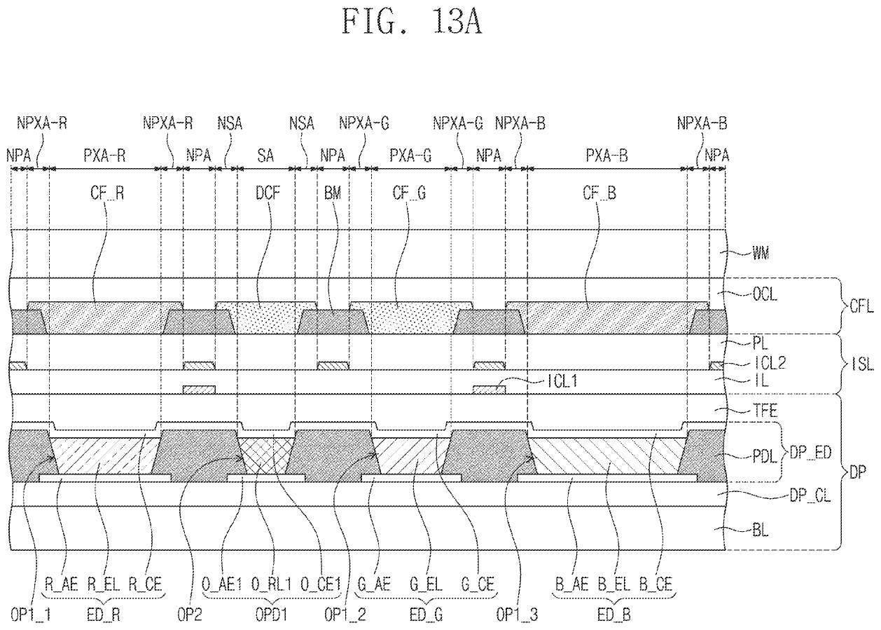

FIG. 12A is an enlarged view of a portion of a circuit layer according to an embodiment of the inventive concept. FIG. 12A is an enlarged view of the area DD′ of FIG. 7. FIG. 12B is an enlarged view of the area XX′ of FIG. 12A.

Referring to FIG. 12A, the panel driver IC may be connected to the readout wiring 1760 (see FIG. 8F). Here, the panel driver IC may include the readout circuit 500 (see FIG. 3). The readout circuit 500 may be connected to the readout wiring 1760 of the active area DA (see FIG. 7). A wiring extending from the readout circuit 500 to the readout wiring 1760 of the active area DA may be a readout fanout wiring RFO. That is, the readout fanout wiring RFO may extend from the readout circuit 500 to be connected to the readout wiring 1760 of the active area DA.

In FIG. 12B, the readout fanout wiring RFO may cross a control signal wiring SCSL. The control signal wiring SCSL may include a plurality of wirings extending in the second direction DR2. The control signal wiring SCSL may be wiring to provide a control signal such as the first control signal SCS (see FIG. 3) or the second control signal ECS (see FIG. 3) to the scan driver 300 (see FIG. 3) or the emission driver 350 (see FIG. 3). The control signal wiring SCSL may include various signal wirings such as, for example, a clock wiring that provides a clock signal to the scan driver 300 or the emission driver 350.

The first reset voltage reinforcement wiring VRST_W1 may be disposed between the data wiring DL and the readout fanout wiring RFO. Accordingly, the first reset voltage reinforcement wiring VRST_W1 may prevent a coupling phenomenon from occurring between the data wiring DL and the readout fanout wiring RFO. The first reset voltage reinforcement wiring VRST_W1 may overlap the data wiring DL. The first reset voltage reinforcement wiring VRST_W1 may be disposed between the data wiring DL and the readout fanout wiring RFO. For example, the readout fanout wiring RFO may be disposed in the first conductive layer 1200 (see FIG. 8C) and/or the second conductive layer 1300 (see FIG. 8D), the data wiring DL may be disposed in the fifth conductive layer 1700 (see FIG. 8F), and the first reset voltage reinforcement wiring VRST_W1 may be disposed in the fourth conductive layer 1600.

The first reset voltage reinforcement wiring VRST_W1 may shield the data wiring DL from the readout fanout wiring RFO by being disposed between the data wiring DL and the readout fanout wiring RFO to screen the data wiring DL. That is, the first reset voltage reinforcement wiring VRST_W1 may prevent the sensing signals output from the readout fanout wiring RFO from being coupled with the data signals applied to the data wiring DL. Accordingly, the sensing accuracy of the sensors FX (see FIG. 3) may be increased.

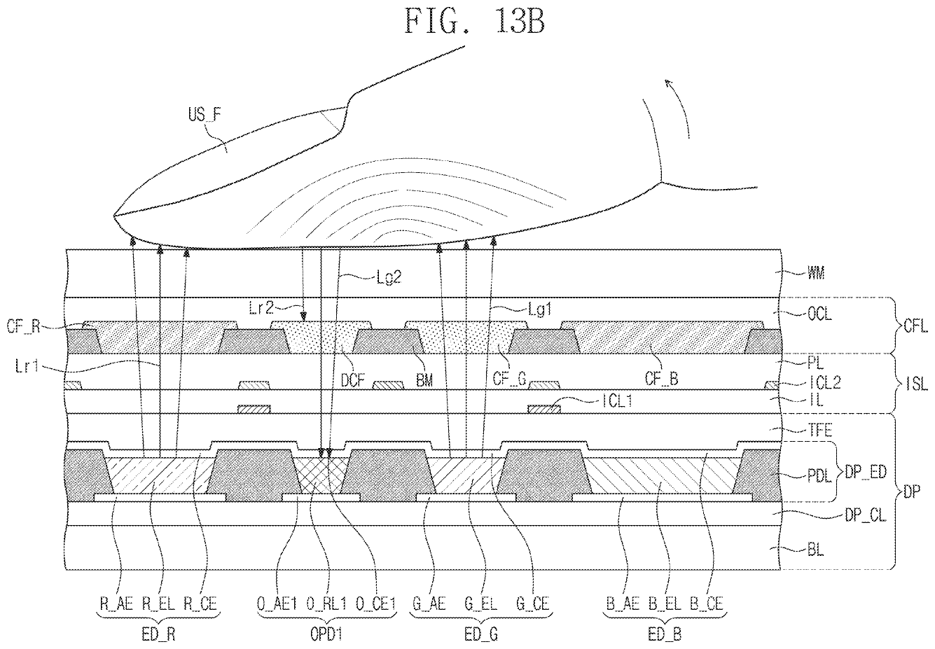

FIGS. 13A and 13B are cross-sectional views illustrating light emitting elements and a light receiving element of a display panel according to an embodiment of the inventive concept.

Referring to FIGS. 13A and 13B, a first electrode layer is disposed on a circuit layer DP_CL. A pixel defining film PDL is provided on the first electrode layer. The first electrode layer may include red, green, and blue anode electrodes R_AE, G_AE, and B_AE. First to third light emitting openings OP1_1, OP1_2, and OP1_3 of the pixel defining film PDL respectively expose at least portions of the red, green, and blue anode electrodes R_AE, G_AE, and B_AE. In an embodiment of the inventive concept, the pixel defining film PDL may further include a black material. The pixel defining film PDL may further include carbon black or a black organic dye/pigment such as aniline black. The pixel defining film PDL may be provided by a material obtained by mixing a blue organic material and a black organic material. The pixel defining film PDL may further include a liquid-repellent organic material.

As illustrated in FIG. 13A, a display panel DP may include first to third light emitting areas PXA-R, PXA-G, and PXA-B, and first to third non-light emitting areas NPXA-R, NPXA-G, and NPXA-B adjacent to the first to third light emitting areas PXA-R, PXA-G, and PXA-B, respectively. Each of the non-light emitting areas NPXA-R, NPXA-G, and NPXA-B may surround a corresponding one of the light emitting areas PXA-R, PXA-G, and PXA-B. In an embodiment, the first light emitting area PXA-R is defined to correspond to a partial area of the red anode electrode R_AE exposed by the first light emitting opening OP1_1. The second light emitting area PXA-G is defined to correspond to a partial area of the green anode electrode G_AE exposed by the second light emitting opening OP1_2. The third light emitting area PXA-B is defined to correspond to a partial area of the blue anode electrode B_AE exposed by the third light emitting opening OP1_3. A non-pixel area NPA may be defined between the first to third non-light emitting areas NPXA-R, NPXA-G, and NPXA-B.

A light emitting layer may be disposed on the first electrode layer. The light emitting layer may include red, green, and blue light emitting layers R_EL, G_EL, and B_EL. The red, green, and blue light emitting layers R_EL, G_EL, and B_EL may be disposed in areas respectively corresponding to the first to third light emitting openings OP1_1, OP1_2, and OP1_3. The red, green, and blue light emitting layers R_EL, G_EL, and B_EL may be separately provided. Each of the red, green, and blue light emitting layers R_EL, G_EL, and B_EL may include an organic material and/or an inorganic material. Each of the red, green, and blue light emitting layers R_EL, G_EL, and B_EL may generate colored light having a predetermined color. For example, the red light emitting layer R_EL may generate red light, the green light emitting layer G_EL may generate green light, and the blue light emitting layer B_EL may generate blue light.

Although the red, green, and blue light emitting layers R_EL, G_EL, and B_EL, which are patterned, are illustrated as an example, embodiments of the inventive concept are not limited thereto. For example, in an embodiment, one light emitting layer may be disposed in common in the first to third light emitting areas PXA-R, PXA-G, and PXA-B. In this case, the light emitting layer may generate white light or blue light. In addition, the light emitting layer may have a multilayer structure referred to as tandem.

Each of the red, green, and blue light emitting layers R_EL, G_EL, and B_EL may include a low molecular weight organic material or a high molecular weight organic material as a light emitting material. Alternatively, each of the red, green, and blue light emitting layers R_EL, G_EL, and B_EL may include a quantum dot material as a light emitting material. The core of the quantum dot may be selected from a group of, for example, a group II-VI compound, a group III-V compound, a group IV-VI compound, a group IV element, a group IV compound, and a combination thereof.

A second electrode layer is disposed on the red, green, and blue light emitting layers R_EL, G_EL, and B_EL. The second electrode layer may include red, green, and blue cathode electrodes R_CE, G_CE, and B_CE. The red, green, and blue cathode electrodes R_CE, G_CE, and B_CE may be electrically connected to each other. According to an embodiment of the inventive concept, the red, green, and blue cathode electrodes R_CE, G_CE, and B_CE may have an integral shape with each other. In this case, the red, green, and blue cathode electrodes R_CE, G_CE, and B_CE may be disposed in common in the first to third light emitting areas PXA-R, PXA-G, and PXA-B, the first to third non-light emitting areas NPXA-R, NPXA-G, and NPXA-B, and the non-pixel area NPA.

An element layer DP_ED may further include a first light receiving element OPD1. The first light receiving element OPD1 may be a photodiode. The pixel defining film PDL may further include a light receiving opening OP2 provided to correspond to the first light receiving element OPD1.

The first light receiving element OPD1 may include a first sensing anode electrode O_AE1, a first photoelectric conversion layer O_RL1, and a sensing cathode electrode O_CE1. The first sensing anode electrode O_AE1 may be disposed on the same layer as the first electrode layer. That is, the first sensing anode electrode O_AE1 may be disposed on the circuit layer DP_CL and may be provided through the same process and at the same time as the red, green, and blue anode electrodes R_AE, G_AE, and B_AE.

The light receiving opening OP2 of the pixel defining film PDL exposes at least a portion of the first sensing anode electrode O_AE1. The first photoelectric conversion layer O_RL1 is disposed on the portion of the first sensing anode electrode O_AE1 exposed by the light receiving opening OP2. The first photoelectric conversion layer O_RL1 may include an organic photo-sensing material. The sensing cathode electrode O_CE1 may be disposed on the first photoelectric conversion layer O_RL1. The sensing cathode electrode O_CE1 may be provided through the same process and at the same time as the red, green, and blue cathode electrodes R_CE, G_CE, and B_CE. According to an embodiment of the inventive concept, the sensing cathode electrode O_CE1 may have an integral shape together with the red, green, and blue cathode electrodes R_CE, G_CE, and B_CE, thereby providing a common cathode electrode C_CE.

An encapsulation layer TFE is disposed on the element layer DP_ED. The encapsulation layer TFE includes at least an inorganic layer or an organic layer. In an embodiment of the inventive concept, the encapsulation layer TFE may include two inorganic layers and an organic layer disposed therebetween. In an embodiment of the inventive concept, the encapsulation layer TFE may include a plurality of inorganic layers and a plurality of organic layers that are alternately laminated.

Each of the inorganic layers of the encapsulation layer TFE may protect red, green, and blue light emitting elements ED_R, ED_G, and ED_B and the first light receiving element OPD1 from moisture/oxygen, and the organic layer of the encapsulation layer TFE may protect the red, green, and blue light emitting elements ED_R, ED_G, and ED_B and the first light receiving element OPD1 from foreign matter such as, for example, dust particles. The inorganic layer of the encapsulation layer TFE may include, for example, a silicon nitride layer, a silicon oxynitride layer, a silicon oxide layer, a titanium oxide layer, an aluminum oxide layer, or the like, and is not particularly limited thereto. The organic layer of the encapsulation layer TFE may include an acrylic organic layer and is not particularly limited.

A display device DD includes an input sensing layer ISL disposed on the display panel DP and a color filter layer CFL disposed on the input sensing layer ISL.

The input sensing layer ISL may be directly disposed on the encapsulation layer TFE. The input sensing layer ISL includes a first conductive layer ICL1, an insulating layer IL, a second conductive layer ICL2, and a protective layer PL. The first conductive layer ICL1 may be disposed on the encapsulation layer TFE. Although a structure in which the first conductive layer ICL1 is directly disposed on the encapsulation layer TFE is illustrated in FIGS. 13A and 13B, embodiments of the inventive concept are not limited thereto. The input sensing layer ISL may further include a base insulating layer disposed between the first conductive layer ICL1 and the encapsulation layer TFE. In this case, the encapsulation layer TFE may be covered by the base insulating layer, and the first conductive layer ICL1 may be disposed on the base insulating layer. According to an embodiment of the inventive concept, the base insulating layer may include an inorganic insulating material.

The insulating layer IL may cover the first conductive layer ICL1. The second conductive layer ICL2 is disposed on the insulating layer IL. Although a structure in which the input sensing layer ISL includes the first and second conductive layers ICL1 and ICL2 is illustrated, embodiments of the inventive concept are not limited thereto. For example, the input sensing layer ISL may include only one of the first and second conductive layers ICL1 and ICL2.

The protective layer PL may be disposed on the second conductive layer ICL2. The protective layer PL may include an organic insulating material. The protective layer PL may serve to protect the first and second conductive layers ICL1 and ICL2 from, for example, moisture/oxygen and serve to protect the first and second conductive layers ICL1 and ICL2 from, for example, foreign matter.

The color filter layer CFL may be disposed on the input sensing layer ISL. The color filter layer CFL may be directly disposed on the protective layer PL. The color filter layer CFL may include a first color filter CF_R, a second color filter CF_G, and a third color filter CF_B. The first color filter CF_R has a first color, the second color filter CF_G has a second color, and the third color filter CF_B has a third color. According to an embodiment of the inventive concept, the first color may be red, the second color may be green, and the third color may be blue.

The color filter layer CFL may further include a dummy color filter DCF. According to an embodiment of the inventive concept, when an area in which the photoelectric conversion layer O_RL1 is disposed is defined as a sensing area SA, and an area on the periphery of the sensing area SA is defined as a non-sensing area NSA, the dummy color filter DCF may be disposed to correspond to the sensing area SA. The dummy color filter DCF may overlap the sensing area SA and the non-sensing area NSA. According to an embodiment of the inventive concept, the dummy color filter DCF may have the same color as one of the first to third color filters CF_R, CF_G, and CF_B. According to an embodiment of the inventive concept, the dummy color filter DCF may have a green color the same as that of the second color filter CF_G.

The color filter layer CFL may further include a black matrix BM. The black matrix BM may be disposed to correspond to the non-pixel area NPA. The black matrix BM may overlap the first and second conductive layers ICL1 and ICL2 in the non-pixel area NPA. According to an embodiment of the inventive concept, the black matrix BM may overlap the non-pixel area NPA and the first to third non-light emitting areas NPXA-R, NPXA-G, and NPXA-B. According to an embodiment of the inventive concept, the black matrix BM does not overlap the first to third light emitting areas PXA-R, PXA-G, and PXA-B.

The color filter layer CFL may further include an overcoating layer OCL. The overcoating layer OCL may include an organic insulating material. The overcoating layer OCL may be provided with a thickness appropriate to remove a step between the first to third color filters CF_R, CF_G, and CF_B. The overcoating layer OCL may include, without particular limitation, a material as long as the material has a predetermined thickness and is capable of planarizing an upper surface of the color filter layer CFL, and may include, for example, an acrylate-based organic material.

Referring to FIG. 13B, when the display device DD (see FIG. 1) operates, each of the red, green, and blue light emitting elements ED_R, ED_G, and ED_B may output light. The red light emitting elements ED_R output red light of a red light wavelength band, the green light emitting elements ED_G output green light of a green light wavelength band, and the blue light emitting elements ED_B output blue light of a blue light wavelength band.

According to an embodiment of the inventive concept, the first light receiving element OPD1 may receive light from specific light emitting elements (e.g., the green light emitting elements ED_G) among the red, green, and blue light emitting elements ED_R, ED_G, and ED_B. That is, the first light receiving element OPD1 may receive reflected green light Lg2 generated by reflection, by a user's fingerprint, of the green light Lg1 output from the green light emitting elements ED_G. The green light Lg1 and the reflected green light Lg2 may be light of a green light wavelength band. The dummy color filter DCF is disposed on the first light receiving element OPD1. The dummy color filter DCF may have a green color. Accordingly, the reflected green light Lg2 may pass through the dummy color filter DCF to be incident on the first light receiving element OPD1.

According to an embodiment, red light and blue light output respectively from the red and blue light emitting elements ED_R and ED_B may also be reflected by a user's finger US_F. For example, when reflected red light Lr2 is defined as light generated by reflection, by the user's finger US_F, of red light Lr1 output from the red light emitting elements ED_R, the reflected red light Lr2 may not be capable of passing through the dummy color filter DCF and may be absorbed by the dummy color filter DCF. Accordingly, the reflected red light Lr2 may not be capable of passing through the dummy color filter DCF and may not be incident on the first light receiving element OPD1. Likewise, when blue light is reflected by the user's finger US_F, the reflected blue light may be absorbed by the dummy color filter DCF. Accordingly, only the reflected green light Lg2 may be provided to the first light receiving element OPD1.

As is traditional in the field of the inventive concept, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

According to an embodiment of the inventive concept, the sensing performance and sensing uniformity of the sensors in the active area may be improved by including the reinforcement wirings in the peripheral area and by disposing the signal wirings so that the signal wirings do not overlap each other.

While the present inventive concept has been particularly shown and described with reference to embodiments thereof, it will be understood by those of ordinary skill in the art that various changes in form and detail may be made therein without departing from the spirit and scope of the present inventive concept as defined by the following claims.

What is claimed is:

1. A display device, comprising:
a base layer;
a circuit layer disposed on the base layer; and
an element layer disposed on the circuit layer and comprising a light emitting element and a light receiving element,
wherein the circuit layer comprises:
a pixel driving circuit connected to the light emitting element;
a sensor driving circuit connected to the light receiving element;
a plurality of reset voltage wirings disposed in an active area and configured to provide a reset voltage to the sensor driving circuit; and
a reset voltage reinforcement wiring disposed in a peripheral area, which is adjacent to the active area, and connected to the plurality of reset voltage wirings and extending in a first direction.

2. The display device of claim 1, wherein the reset voltage reinforcement wiring has a bar shape extending in one direction.

3. The display device of claim 1, wherein the peripheral area comprises a first peripheral area defined on an upper side of the active area and a second peripheral area disposed on a lower side of the active area, and
the reset voltage reinforcement wiring comprises a first reset voltage reinforcement wiring disposed in the first peripheral area and a second reset voltage reinforcement wiring disposed in the second peripheral area.

4. The display device of claim 3, wherein the circuit layer comprises:
a first conductive layer disposed on the base layer;
a second conductive layer disposed on the first conductive layer and comprising a gate wiring;
a third conductive layer disposed on the second conductive layer and comprising the reset voltage wirings; and
a fourth conductive layer disposed on the third conductive layer and comprising a readout wiring.

5. The display device of claim 4, wherein the circuit layer further comprises:
a first driving voltage wiring disposed in the peripheral area and configured to provide a driving voltage to the pixel driving circuit,
wherein the first driving voltage wiring is disposed closer to the active area than the reset voltage reinforcement wiring.

6. The display device of claim 5, wherein the first driving voltage wiring is disposed in the first conductive layer.

7. The display device of claim 5, wherein the circuit layer further comprises:
a second driving voltage wiring disposed in the second peripheral area,
wherein the second driving voltage wiring is disposed farther from the active area than the second reset voltage reinforcement wiring.

8. The display device of claim 7, wherein the second driving voltage wiring is disposed in at least one of the third conductive layer or the fourth conductive layer.

9. The display device of claim 4, wherein the first reset voltage reinforcement wiring is disposed in the third conductive layer and the second conductive layer.

10. The display device of claim 4, wherein the second reset voltage reinforcement wiring is disposed in the third conductive layer.

11. The display device of claim 4, wherein the peripheral area further comprises a third peripheral area and a fourth peripheral area respectively defined on left and right sides of the active area,
wherein the circuit layer further comprises:
a reset control reinforcement wiring disposed in the third peripheral area and the fourth peripheral area and connected to a reset control wiring of the active area;
a first initialization voltage reinforcement wiring connected to a first initialization voltage wiring of the active area; and
a second initialization voltage reinforcement wiring connected to a second initialization voltage wiring of the active area.

12. The display device of claim 11, wherein each of the reset control reinforcement wiring, the first initialization voltage reinforcement wiring, and the second initialization voltage reinforcement wiring has a bar shape extending in a second direction crossing the first direction.

13. The display device of claim 11, wherein the reset control reinforcement wiring, the first initialization voltage reinforcement wiring, and the second initialization voltage reinforcement wiring are disposed in the fourth conductive layer.

14. The display device of claim 13, wherein the circuit layer further comprises:
a first connection pattern configured to connect the reset control reinforcement wiring and the reset control wiring;
a second connection pattern configured to connect the first initialization voltage reinforcement wiring and the first initialization voltage wiring; and
a third connection pattern configured to connect the second initialization voltage reinforcement wiring and the second initialization voltage wiring.

15. The display device of claim 11, further comprising:
at least one panel driver to which the reset control reinforcement wiring is connected; and
a scan driver configured to receive a control signal.

16. The display device of claim 15, wherein the circuit layer further comprises:
a control signal wiring connected to the scan driver and configured to provide the control signal to the scan driver; and
a readout fanout wiring crossing the control signal wiring and connecting the readout wiring to the panel driver,
wherein the reset voltage reinforcement wiring overlaps the control signal wiring and is disposed between the control signal wiring and the readout fanout wiring in a thickness direction of the circuit layer.

17. The display device of claim 16, wherein the readout fanout wiring is disposed in the second conductive layer, the control signal wiring is disposed in the fourth conductive layer, and the reset voltage reinforcement wiring is disposed in the third conductive layer.

18. A display device, comprising:
a base layer;
a circuit layer disposed on the base layer; and
an element layer disposed on the circuit layer and comprising a light emitting element and a light receiving element,
wherein the circuit layer comprises:
a reset voltage reinforcement wiring disposed in a first peripheral area and a second peripheral area and connected to reset voltage wirings of an active area,
wherein an image is displayed in the active area, the first peripheral area is disposed on an upper side of the active area, the second peripheral area is disposed on a lower side of the active area, a third peripheral area is disposed on a left side of the active area, and a fourth peripheral area is disposed on a right side of the active area; and
a reset control reinforcement wiring, a first initialization voltage reinforcement wiring, and a second initialization voltage reinforcement wiring disposed in the third peripheral area and the fourth peripheral area.

19. The display device of claim 18, wherein the reset voltage reinforcement wiring has a bar shape extending in a first direction.

20. The display device of claim 19, wherein each of the reset control reinforcement wiring, the first initialization voltage reinforcement wiring, and the second initialization voltage reinforcement wiring has a bar shape extending in a second direction crossing the first direction.

21. The display device of claim 20, wherein, in the first direction, the reset control reinforcement wiring is disposed closer to the active area than the first initialization voltage reinforcement wiring is disposed, and the second initialization voltage reinforcement wiring is disposed between the reset control reinforcement wiring and the first initialization voltage reinforcement wiring.

22. The display device of claim 18, wherein the circuit layer comprises:
a first conductive layer disposed on the base layer;
a second conductive layer disposed on the first conductive layer and comprising a gate wiring;
a third conductive layer disposed on the second conductive layer and comprising the reset voltage wirings; and
a fourth conductive layer disposed on the third conductive layer and comprising a readout wiring.

23. The display device of claim 22, wherein the reset voltage reinforcement wiring comprises a first reset voltage reinforcement wiring disposed in the first peripheral area and a second reset voltage reinforcement wiring disposed in the second peripheral area.

24. The display device of claim 23, wherein the first reset voltage reinforcement wiring is disposed in the third conductive layer and the fourth conductive layer, and the second reset voltage reinforcement wiring is disposed in the third conductive layer.

25. The display device of claim 22, wherein the reset control reinforcement wiring, the first initialization voltage reinforcement wiring, and the second initialization voltage reinforcement wiring are disposed in the fourth conductive layer.

26. The display device of claim 22, wherein the circuit layer further comprises:
a control signal wiring configured to receive a control signal; and
a readout fanout wiring crossing the control signal wiring and connected to the readout wiring,
wherein the reset voltage reinforcement wiring overlaps the control signal wiring and is disposed between the control signal wiring and the readout fanout wiring in a thickness direction of the circuit layer, and shields the control signal wiring from the readout fanout wiring.

27. The display device of claim 26, wherein the readout fanout wiring is disposed in the second conductive layer, the control signal wiring is disposed in the fourth conductive layer, and the reset voltage reinforcement wiring is disposed in the third conductive layer.

28. The display device of claim 18, wherein the circuit layer further comprises:
a pixel driving circuit connected to the light emitting element; and
a sensor driving circuit connected to the light receiving element,
wherein the reset voltage reinforcement wiring and the reset control reinforcement wiring are connected to the sensor driving circuit.
